(19) United States
(12) Patent Application Publication
(10) Pub. No.: US 2026/0064122 A1
(43) Pub. Date: Mar. 5, 2026

(54) ARTIFICIAL INTELLIGENCE-BASED SYSTEM AND METHOD FOR OBJECT DETECTION AND NAVIGATION

(71) Applicant: Field AI, Inc., Mission Viejo, CA (US)

(72) Inventors: Muhammad Fadhil GINTING, Aliso Viejo, CA (US); David Fan, Lake Forest, CA (US); Sung Kyun KIM, Irvine, CA (US); Aliakbar AGHAMOHAMMADI, Mission Viejo, CA (US)

(73) Assignee: Field AI, Inc., Mission Viejo, CA (US)

(21) Appl. No.: 19/320,757

(22) Filed: Sep. 5, 2025

Related U.S. Application Data
(60) Provisional application No. 63/690,831, filed on Sep. 5, 2024.

(51) Int. Cl. G05D 1/43; G05D 101/10; G06N 7/01

(52) U.S. Cl. CPC G05D 1/43; G06N 7/01; G05D 2101/10

(57) ABSTRACT

An object-goal navigation framework for an autonomous mobile robot uses a dynamic Scene Graph (DSG) and a Relational Semantic Network (RSN) for semantic-guided object-goal navigation. The DSG is a hierarchical world representation generated from a prior spatial configuration of the environment. The RSN encodes relational semantic knowledge between objects and the regions or rooms in the environment. The object-goal navigation problem is then solved using a probabilistic planning framework with relational semantic knowledge. Using DSG and RSN, the global planning problem is formulated as a Markov decision process (MDP). The computed global planning policy directs the robot to visit a room or perform local searches. A finite state local controller is then used to execute the global planning policy and search for the target object.

### CROSS-REFERENCE TO RELATED APPLICATION

This application claims priority to and the benefit of the filing date of provisional U.S. Patent Application No. 63/690,831, entitled “ARTIFICIAL INTELLIGENCE-BASED SYSTEM AND METHOD FOR OBJECT DETECTION AND NAVIGATION” and filed on Sep. 5, 2024, the entire contents of which is hereby expressly incorporated herein by reference.

### TECHNICAL FIELD

The present disclosure relates generally to semantic reasoning systems for autonomous robots, and, in particular, to artificial intelligence-based semantic reasoning systems for object detection and navigation.

### BACKGROUND

Autonomous, mobile robots are frequently required to perform search and inspection related tasks, such as finding and reading gauges, capturing thermal images, inspecting various components, and navigating stairs in a complex and unknown environment, often alongside humans. The robot must reason where to find the objects in the environment and search for the objects efficiently. This is referred to as an object-goal navigation problem. Object-goal navigation can be challenging due to the large search space for the robot to consider when deciding where to go and inspect. The target object may be located in one room among many rooms in a building, and thus, uninformed brute-force search can be significantly inefficient. Current search and navigation schemes typically rely on sensory information onboard the robot and, unlike humans, are incapable of drawing upon prior knowledge and contextual understanding to refine their search strategies. Decision making without prior knowledge and without context can lead to inefficient search policies.

Another problem faced in autonomous robot search and navigation is the limited ability to consider semantic information in planning and decision-making. For example, the robot may need to examine and interact with different types of objects dispersed throughout the environment, such as high-resolution object inspection, reading gauge measurements, and navigating through stairs and alongside humans. To accomplish its objective, the robot must identify and reason about the semantic information of these objects and make decisions based on this information. However, performing semantic-based planning in unknown environments can be challenging due to lack of or inability to use prior knowledge of the environment and due to perceptual uncertainty, which can be attributed to limitations in sensing range, false detections, localization errors, and occlusions. Furthermore, robot planning and control frameworks traditionally rely on geometric information, so integrating semantic information is not a straightforward task.

In addition, in industrial settings, robot tasks are often supported by extensive documentation like operating manuals, training material, and additional written expert knowledge used to train human workers. To complete these tasks, the robot must perceive the environment, plan feasible actions, all while adhering to the established procedures and safety protocols outlined in these documents. However, task planning while ensuring robot compliance with relevant documentation and written expert guidelines remains a challenge due to the distinct ways robots interact with their environment relative to humans. Robots also have limited context capacity, which constrains the amount of expert knowledge they are capable of efficiently processing.

Hence, there is a need for improving the ability of planning and control frameworks of robots to consider prior knowledge, contextual information, perceptual uncertainty, and semantic information in planning and decision-making while performing search, navigation, and inspection tasks while at the same time ensuring the robot's compliance with relevant documentation and written expert guidelines.

### SUMMARY

In one general aspect, the instant disclosure presents a data processing system for an autonomous mobile robot having a processor and a memory in communication with the processor wherein the memory stores executable instructions that, when executed by the processor alone or in combination with other processors, cause the data processing system to perform multiple functions. The function include generating a dynamic scene graph (DSG) of an environment in which the autonomous mobile robot is operating based on spatial configuration data of the environment, the DSG being generated offline; generating a relational semantic network (RSN) and training the RSN to estimate probabilities of finding target objects in a plurality of different semantic room types using common-sense knowledge, the RSN being initialized and trained offline; after the DSG and the RSN have been generated, receiving a user query at a control system of the autonomous mobile robot, the user query specifying a target object to search for in the environment; generating a global search policy for the autonomous mobile robot which defines a plan for navigating through all rooms in the environment to find the target object using a global planner, the global search policy being generated based on relational semantic knowledge encoded in the RSN; generating a robot control policy based on the global search policy using a local finite state controller, the robot control policy defining how the autonomous mobile robot searches each of the rooms in the environment; and controlling the autonomous mobile robot according to the global search policy and the robot control policy.

In yet another general aspect, the instant disclosure presents a method for performing object-goal navigation for an autonomous mobile robot. The method includes generating a dynamic scene graph (DSG) of an environment in which the autonomous mobile robot is operating based on spatial configuration data of the environment, the DSG being generated offline; training a relational semantic network (RSN) to estimate probabilities of finding target objects in a plurality of different semantic room types using common-sense knowledge, the RSN being initialized and trained offline; after the DSG and the RSN have been generated, receiving a user query at a control system of the autonomous mobile robot, the user query specifying a target object to search for in the environment; generating a global search policy for the autonomous mobile robot which defines a plan for navigating through all rooms in the environment to find the target object using a global planner, the global search policy being generated based on relational semantic knowledge encoded in the RSN; generating a robot control policy based on the global search policy using a local finite state controller, the robot control policy defining how the autonomous mobile robot searches each of the rooms in the environment; and controlling the autonomous mobile robot according to the global search policy and the robot control policy.

In a further general aspect, the instant application describes a non-transitory computer readable medium on which are stored instructions that when executed cause a programmable device to perform functions of generating a dynamic scene graph (DSG) of an environment in which a autonomous mobile robot is operating based on spatial configuration data of the environment, the DSG being generated offline; training a relational semantic network (RSN) to estimate probabilities of finding target objects in a plurality of different semantic room types using common-sense knowledge, the RSN being initialized and trained offline; after the DSG and the RSN have been generated, receiving a user query at a control system of the autonomous mobile robot, the user query specifying a target object to search for in the environment; generating a global search policy for the autonomous mobile robot which defines a plan for navigating through all rooms in the environment to find the target object using a global planner, the global search policy being generated based on relational semantic knowledge encoded in the RSN; generating a robot control policy based on the global search policy using a local finite state controller, the robot control policy defining how the autonomous mobile robot searches each of the rooms in the environment; and controlling the autonomous mobile robot according to the global search policy and the robot control policy. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 shows an example implementation of an autonomous mobile robot in which aspects of the disclosure may be implemented.

FIG. 2 shows an example implementation of a framework for facilitating object-goal navigation for an autonomous mobile robot, such as the robot of FIG. 1

FIG. 3 shows an example global search policy generating by a global planner of the framework of FIG. 2.

FIG. 4 shows an example implementation of a framework for facilitating planning and decision-making using semantic information for autonomous mobile robots, such as the robot of FIG. 1.

FIG. 5 is a schematic illustration showing a comparison of robot paths for object inspections using the framework of FIG. 4 and baseline methods in a simulation.

FIG. 6 shows graphs of the number of inspected objects (left) and the sum of the closest distance to the all 10 objects over time (right) for inspections using the framework of FIG. 4.

FIG. 7 shows an example implementation of a framework for facilitating compliant task planning for autonomous mobile robots, such as the robot of FIG. 1.

FIG. 8 shows graphs depicting compliance & completion rate and context retrieval accuracy from different types of user queries.

FIG. 9 shows a flowchart of an example method for implementing a task planning framework for object-goal navigation.

FIG. 10 is a block diagram showing an example software architecture, various portions of which may be used in conjunction with various hardware architectures herein described, which may implement any of the described features.

FIG. 11 is a block diagram showing components of an example machine configured to read instructions from a machine-readable medium and perform any of the features described herein.

### DETAILED DESCRIPTION

As noted above, performing object-goal navigation and semantic-based planning in unseen environments is challenging for a number of reasons. For example, existing systems struggle with an inherent uncertainty and variability present in real-world environments. While humans naturally use their understanding of object relationships and spatial configurations to guide their search, replicating this capability in artificial systems has proven difficult. Furthermore, a dynamic nature of many environments poses additional challenges. The objects may be moved, occluded, or placed in unexpected locations, requiring search systems to adapt and update their strategies based on new observations. In addition, robots are typically incapable of drawing upon prior knowledge and contextual understanding to refine their search strategies. Decision making without prior knowledge and without context can lead to inefficient search policies.

Coverage planning is one previously known method that has been used to enable robots to explore and map environments. In addition to mapping the whole environment, inspection tasks often require the robot to closely examine specific target objects of interest in some part of the environment. Current approaches for inspecting specific targets usually rely on predefining routes and observation points for the robot or placing identifiable tags, such as QR codes, in the environment. However, this process is labor-intensive for humans. Recent approaches to addressing this problem involve training an object detector and incorporating a detection model into the planning process. However, these methods are often inefficient in locating the object, particularly in an environment with a large search space, because these methods make the robot cover all unexplored areas in the environment until it detects the target object.

Some object search and inspection schemes use semantic knowledge for mapping and/or planning purposes. Semantic active mapping is one example of a scheme. In this scheme, robots gather semantic information from their surroundings using techniques like object detection and semantic segmentation. The objective of semantic active mapping is usually defined to maximize information gain, cover meshes, and improve the reconstruction quality of the objects. This method may utilize a path planning algorithm that explores a new space while improving the object observation resolution on a volumetric map. Some active mapping schemes sample candidate trajectories and add semantics-aware cost to improve the object-centric mapping. However, in many environments, objects of interest are hard to detect without a careful search. In such environments, previously known active mapping schemes can result in false detections or detections with low object classification confidence.

As another example, some schemes use semantic-based task planning to switch between object-based inspection behaviors. However, defining transition conditions for object search and mapping remains a challenge. Due to semantic detection uncertainty, the reactive transition between exploration and object inspection based on object detection signals can be brittle. Consequently, behavior transitions for object inspection is usually based on a predefined time or assumes perfect semantic observation.

For these schemes, robots gather semantic information from their surroundings using techniques like object detection and semantic segmentation. This information can be represented in various forms, such as volumetric voxel maps, neural radiance fields (NeRF), or 3D dynamic scene graphs (DSGs). Artificial intelligence (AI) models, such as Large Language Models (LLMs), may be used to extract semantic information from the environment and process this information for planning and decision-making purposes. While LLMs can be directly queried to make decisions, their planning and reasoning capabilities still raise uncertainties. In addition, LLM-based schemes typically implement a semantic frontier selection approach to bias exploration in the direction where target objects may be located. However, this approach does not take detection accuracy into consideration and is therefore susceptible to false positive object detections due to perceptual uncertainty.

The difficulties posed in navigation and task planning for robots can be exacerbated by the fact that robot actions must also comply with domain-specific operational knowledge in the form of operational manuals, training manuals, instruction manuals, and other written expert knowledge. Current methods for generating robot goals and plans rely on common sense knowledge encoded in large language models. However, these approaches are limited to generic robotics problems, as field robotics in industrial settings often require proprietary knowledge not publicly available or usable for training general purpose foundation models. Another approach includes fine-tuning distinct models for each potential operational situation to ensure compliance, which is typically not feasible for deployment to new sites and customers. In addition, due to limited context capacity, models are limited in the amount of domain-specific knowledge that they can process efficiently during task planning. Finding ways to identify and retrieve only relevant contexts from often extensive amounts of operational documentation to enable compliant task planning remains an ongoing concern.

To address the technical challenges and problems posed in object-goal navigation, semantic-based task planning and search behavior, and compliant task planning, the present disclosure presents technical solutions in the form of frameworks, algorithms, and schemes that enables prior environment information, semantic knowledge, and domain-specific context information to be taken into consideration for autonomous robot planning and decision-making. In particular, to address problems associated with object-goal navigation and task planning, the present disclosure provides a framework referred to as Semantic Enhanced Exploration and Knowledge (SEEK) that uses prior spatial configuration and relational semantic knowledge for semantic-guided object-goal navigation. SEEK maintains two environment representations: Dynamic Scene Graph (DSG) and a Relational Semantic Network (RSN). The DSG is a hierarchical world representation generated from a prior spatial configuration of the environment. The RSN encodes relational semantic knowledge between objects and the regions or rooms in the environment. The object-goal navigation problem is then solved using a probabilistic planning framework with relational semantic knowledge. Using DSG and RSN, the global planning problem is formulated as a Markov decision process (MDP). The computed global planning policy directs the robot to visit a room or perform local searches. A finite state local controller is then used to execute the global planning policy and search for the target object. This approach enables a principled way to probabilistically combine prior and common sense knowledge with the robot's observation. In contrast with current state-of-the-art methods, which require resource-intensive models or large amounts of data, the RSN is a lightweight model trained with a small amount of data distilled from LLMs. This compact model size is advantageous for real-world inspection robots, which often have limited computational resources and restricted internet access. The RSN updates its semantic knowledge over time based on the robot's observations in the specific environment.

To address technical problems and difficulties associated with implementing semantic-based planning and search behavior, the present disclosure provides a framework referred to as Semantic Belief Behavior Graph (SB2G) which defines multiple object-dependent active semantic search types and semantic-based behaviors. To account for perceptual uncertainty of semantic observations in planning, SB2G maintains both geometric and semantic information of objects of interest as a belief state. To assist the robot in locating inspection targets with high confidence, an active semantic search behavior is implemented that guides the robot in reducing belief uncertainty, directing it toward areas where it can gather more reliable semantic information. The SB2G defines behavior nodes which represent different policies for controlling the robot in performing semantic-based inspection tasks. The SB2G edges govern the transitions between the behavior nodes, triggered either by attaining sufficient belief confidence for semantic-based behaviors or task specifications. This framework enables the robot to search for inspection targets and execute precise inspection behaviors efficiently, exhibiting performance comparable to human-operated inspections.

To address technical problems and difficulties associated with compliant task planning, the present disclosure provides a framework called SayComply that involves building a hierarchical database of context sources, including documents, operational guidance instructions, detailed site-specific information, and robot embodiment safety and operating procedures. As LLMs have limited context length for in-context learning with such a database, SayComply leverages retrieval-augmented LLMs to retrieve relevant information given user instructions to ground robot task planning with operational compliance. When a user query (also referred to as a prompt or instruction) is received, the retrieval-augmented LLM processes the query, identifies domain-specific compliance knowledge that is relevant to the query, retrieves the identified knowledge, and provides the identified knowledge along with the query to a compliant task planning model (e.g., LLM). The retrieval-augmented LLM may also provide guidelines for generating plans that comply with retrieved compliance knowledge. The compliant task planning model then generates compliant task plans for the robot to perform in response to the query. The compliant task planning model may also be instructed to provide feedback to users on non-compliant instructions (i.e., instructions that would result in the robot being non-compliant with operational requirements).

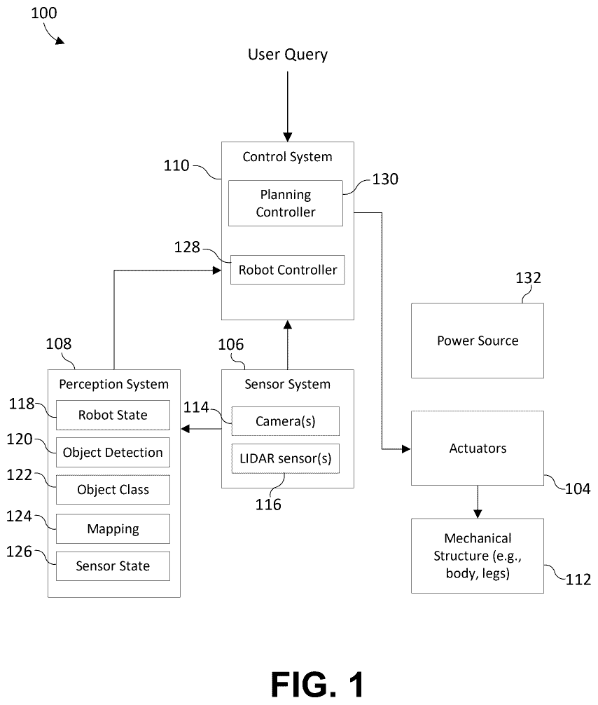

FIG. 1 shows an example implementation of a robot 100 in which aspects of this disclosure may be implemented. The robot 100 includes a mechanical structure 112, actuators 104, sensor system 106, perception system 108, control system 110, and power source 132. The mechanical structure 112 includes the structural elements which form the robot body, locomotion mechanism(s) (e.g., legs, tracks, propeller(s), joints, etc.), and other moving parts. The actuators 104 are hardware which turn energy (e.g., from power source) into physical motion of an associated robot body part or mechanism. The actuators 104 typically comprise electric motors although any suitable type of actuator, including hydraulic/pneumatic actuators, may be used. Actuators 104 can be configured to produce rotary motion, linear motion, or combinations of rotary and/linear motions.

The sensor system 106 includes a plurality of sensors which are used to sense characteristics of the environment and robot state (e.g., pose, orientation, etc.). The sensors 106 may include vision sensors (e.g., cameras), proximity sensors (e.g., ultrasonic and/or capacitive sensors), range sensors (e.g., light-detection and ranging (LIDAR) and Radar sensors), navigation and positioning sensors (e.g., global positions system (GPS) sensors), accelerometers, gyroscopes, inertial measurement units (IMUs), environment sensors (e.g., temperature, light, sound, gas sensors), force sensors, and/or kinematic sensors. In the example of FIG. 1, the sensor system 106 includes at least one camera 114 and at least on LIDAR sensor 116. Sensors can be mounted in any suitable location in and on the robot. Some sensors may have fields of view (FoV), which is the angular or spatial extent of the environment the sensor can detect or capture at any given moment. Sensors may be pivotable and/or rotatable to change the FoV without having to reposition the entire robot.

The perception system 108 receives raw data (i.e., sensor output) from the sensor system 106 and uses algorithms to convert the data to meaningful information. To this end, the perception system 108 includes a plurality of perception modules that uses a predetermined algorithm for performing a perception related task. For example, the perception system 108 may include robot state modules 118, object detection modules 120, object classification modules 122, environment mapping modules 124, and sensor state modules 126. The robot state 118 modules process relevant sensor data to estimate robot pose. Object detection modules 120 process relevant sensor data to detect objects in the environment, and object classification modules 122 process sensor data to identify detected objects (e.g., doors, stairs, fire extinguishers, control panels, etc.). Environment mapping modules 124 monitor sensor information to generate a map of the local environment. Sensor state modules 126 process sensor data to estimate sensor state (e.g., sensor odometry).

The control system 110 is a computer system (i.e., hardware and software) that receives instructions, interprets commands, processes sensor and perception data, plans actions and search behaviors, and communicates with the robot's motors and actuators to cause movements. The control system 110 receives sensor data from the sensor system 106 and perception data from the perception system 108 and uses this information as the basis for controlling the movement and actions performed by the robot. The control system may include various controllers for managing different aspects of robot performance. For example, the control system 110 may include a robot controller 128 for controlling the motion of the robot. The robot controller 128 receives instructions indicating an action to perform and generates commands for the appropriate actuators to perform to action. The robot controller 128 may be configured to identify movement paths, step positions, body poses, and the like required to perform the action. The control system 110 may include a planning controller 130 which receives user instructions or queries and identifies and makes decisions regarding the tasks to perform and/or actions to take to satisfy user instructions and queries. The planning controller 130 implements one or more frameworks, as mentioned above, for processing user instructions and queries to determine plan actions and search behaviors for the robot to execute to satisfy the user instruction or query (explained in more detail below).

The power source 132 provides the energy the robot needs to operate the actuators, sensors, and control systems. The power source 132 is typically electric power although any suitable type of power may be used (e.g., hydraulic, pneumatic, fuel cells, etc.). Electric power may be provided by one or more batteries which may be rechargeable. The amount of power that the power source provides depends on the robot's size, application, and mobility requirements.

As mentioned above, the planning controller 130 implements one or more task planning frameworks for processing user instructions and queries and planning tasks, actions, and behaviors for the robot to perform to satisfy the instructions and queries. One such framework is the SEEK framework. The SEEK framework provides solutions to the problems associated with object-goal navigation and associated task planning in unknown environments.

To define the object-goal navigation problem, first, let xₖ∈X, uₖ∈U, and zₖ∈Z denote the robot state, action, and observation at time step k, respectively. The process model xₖ₊₁=f(xₖ, uₖ) encodes the system dynamics. The robot generates action uₖ according to a policy π. The robot observes and maps various objects in the environment as y={y₁, . . . y_{N}_{ₖ}} with yᵢ∈Y, where Nₖ represents the number of observed objects until time step k. Each object state

$${y}_{i} := ( {y}_{i}^{p} , {y}_{i}^{q} , {y}_{i}^{l} )$$

captures the object's position

$${y}_{i}^{p} , orientation {y}_{i}^{q} ,$$

and semantic class

$${y}_{i}^{l} ∈ L ,$$

respectively.

In partially observable environments, the true state of y is unknown to the robot. If an object yᵢ is visible from the current robot state xₖ, the robot can observe the object. The observation

$${z}_{k} := ( {z}_{k}^{p} , {z}_{k}^{q} , {z}_{k}^{l} , {z}_{k}^{s} )$$

consists of the object's measured position

$${z}_{k}^{p} , orientation {z}_{k}^{q} ,$$

detected class

$${z}_{k}^{l} ,$$

and detection confidence score

$${z}_{k}^{s} .$$

The observation model zₖ=h(xₖ,yₖ) encodes the relationship between (xₖ,yₖ) and zₖ. The estimated state of the objects y and the robot state is represented as a belief bₖ:=(p(xₖ,y| [symbol] ), where [symbol] denotes the history of past observations and actions. bₖ is used as the basis for decision uₖ=π(bₖ). The belief evolution model bₖ₊₁=τ(bₖ,uₖ,zₖ₊₁) updates bₖ and can be computed recursively.

Object-goal navigation: The robot's objective is to search and navigate to a target object y_{G}∈Y for object inspection. The target object is described as the object semantic class y^{l}. The robot successfully navigates to y_{G} when the robot position

$${x}_{k}^{p}$$

is close to the target object

$$‖ {x}_{k}^{p} - {y}_{G}^{p} ‖ < ϵ$$

triggers a finish signal u^{f}. The robot must efficiently search for the object by minimizing the distance traveled to the target object.

Problem 1 (Object-Goal Navigation): Given a target object y_{G}, initial robot state x₀, find an optimal object search policy π*:

$${π}^{*} = {arg min}_{π ∈ Π} {\sum }_{k = 0}^{T - 1} ‖ {x}_{k + 1} - {x}_{k} ‖ \qquad ( 1 )$$

$$s . t . ‖ {x}_{T}^{p} - {y}_{G}^{p} ‖ < ϵ , {u}_{T} = {u}^{f} ,$$

$${x}_{k + 1} = f ( {x}_{k} , π ( {b}_{k} ) ) ,$$

$${z}_{k} ∼ p ( {z}_{k} \vert {x}_{k} , {y}_{k} ) ,$$

$${b}_{k + 1} = τ ( {b}_{k} , π ( {b}_{k} ) , {z}_{k} .$$

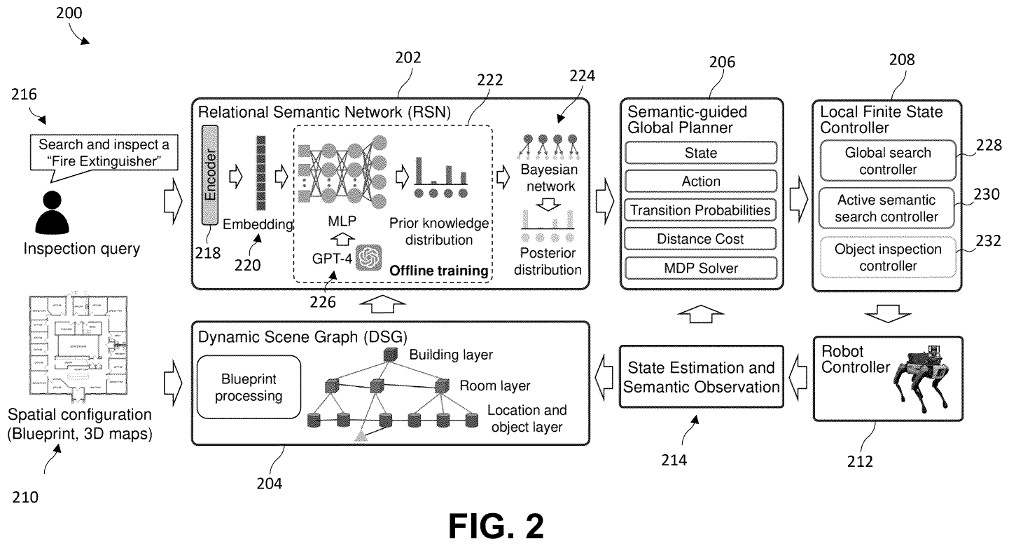

An example implementation of the SEEK framework 200 for a robot that solves the object-goal problem is shown in FIG. 2. The SEEK framework 200 includes an RSN component 202, a DSG component 204, a semantic-guided global planner 206, and a local finite state controller 208. For this framework, two sources of prior semantic knowledge are used to guide the robot in locating the target object. The first source of prior knowledge comes from the spatial configuration of the environment. This information can come from blueprints, floor plans, 3D maps, and Building Information Models (BIM) commonly available in industrial inspection tasks. The spatial configuration provides the names of regions or rooms in the environment that are semantically meaningful in locating the target object. The second source of prior knowledge is the semantic relationship between target objects and room names. The semantic relationship informs which rooms the target object is usually located in. Spatial configuration is maintained in the DSG, and semantic knowledge relationship is maintained in the RSN.

DSG [symbol] =( [symbol] , ε) is a hierarchical representation of the environment. The DSG nodes [symbol] can be partitioned into N layers with

$$𝒱 = {⋃}_{i}^{N} {𝒱}_{i} .$$

Each node v∈ [symbol] ₗ at layer i can only share an edge with at most one parent node in the layer above [symbol] ᵢ₊₁ and can only share edges with nodes in the same or adjacent layers [symbol] ᵢ₋₁, [symbol] _{i′}. The node v∈ [symbol] encodes the node position v^{p}∈ [symbol] ³, orientation v^{q} ∈SO(3), and the semantic class v^{l}∈L. The edges on the same layers represent direct spatial connectivity between the nodes, and the edges between different layers represent how the nodes are spatially grouped together. In the urban environment, the hierarchy levels are named location/objects, rooms or regions, and buildings in ascending order. Prior to the robot deployment, the DSG nodes on the room-level [symbol] and above are initialized from the prior knowledge of the spatial configuration.

RSN [symbol] is a Bayesian network that estimates the probability of finding target objects in the environment P(y_{G})= [symbol] (y_{G}, [symbol] ). The network estimates the probability of finding y_{G} in every room P(y_{G})∈ [symbol] ^{|} [symbol] ^{₂}^{|}. The RSN is initialized using relational semantic knowledge on the object occurrences in different semantic types of rooms. The probability P(y_{G}) is updated as the robot discovers the target object in the environment across planning episodes P(y_{G})ₖ₊₁ P(y_{G}|zₖ₊₁)ₖ, where P(⋅)ₖ represents object probability at time step k.

A probabilistic and hierarchical planning approach is proposed for the object-goal navigation. First, the global planner computes a policy π^{g} for the robot to search for the target object across all rooms [symbol] ₂ using relational semantic knowledge encoded in an RSN. Then, the local planner generates a robot control policy w that moves the robot to a room vᵢ=π⁹(xₖ) while searching for y_{G} in a local area around the robot. This approach enables a more efficient global search by directing the robot to search more promising rooms informed by relational semantic knowledge.

The global planner solves the problem of navigating through a set of rooms [symbol] ₂ with the objective of locating the target object y_{G}. This problem is formulated as a Markov Decision Process (MDP). An MDP is defined by the tuple ( [symbol] , [symbol] , P, C), which represents the state space action space, transition probabilities, and cost function, respectively. The state [symbol] ∈ [symbol] comprises the current room where the robot is within [symbol] ₂, and a goal state [symbol] ^{G}, where the robot finds y_{G}. The action space [symbol] is the set of rooms [symbol] ₂ that the robot can go to [symbol] ^{search}. The size of the action space is | [symbol] |=2| [symbol] ₂|. The action space [symbol] consists of two types of actions: moving to a room [symbol] ^{move} and searching within the current room [symbol] ^{search}. The size of the action space [symbol] is 2| [symbol] ₂|, comprising one action to move to every room and one search action within each room. The transition probabilities P consist of transition probabilities between rooms P( [symbol] ₖ₊₁=vⱼ| [symbol] ₖ=vᵢ, [symbol] ₖ) and transition probabilities to the goal state P( [symbol] ₖ₊₁= [symbol] ^{G}| [symbol] ₖ=vᵢ, [symbol] ₖ). The transition probabilities to the goal state are estimated by the RSN P(y_{G}). The cost function C in our formulation is the expected traversal distance between rooms or the expected distance to search the room of the current robot location. Finally, to compute for an optimal policy for π^{G}, the expected cost-to-go J(X) is minimized such that

$$J ( {𝒳}_{i} ) = {min}_{π ∈ {Π}^{g}} C ( {𝒳}_{i} , 𝒰 ) + J ( {𝒳}_{j} ) \qquad ( 2 )$$

$${π}^{g} = {arg min}_{π ∈ {Π}^{g}} J ( {𝒳}_{i} ) ,$$

where [symbol] ᵢ and [symbol] ⱼ denote the current state and the next state, respectively.

Local planner π^{l} generates a robot control policy w based on the global policy π^{g} and the current belief bₖ. It switches between three controllers to search for and navigate to the target object. The first controller ρₙₐᵥ generates a navigation policy to visit a new room or search the current room based on the action prescribed by π^{g}. When the robot detects a possible sign of the target object using an object detector, the local planner switches to the active semantic search controller ρ_{search}. This controller is triggered when the robot belief bₖ of an object is within the belief set B^{search}. The controller actively gathers new observations to increase its confidence and drive the belief bₖ to reduce the target object's pose and semantic detection uncertainty. If the belief bₖ of target object has low uncertainty, bₖ ∈B^{inspect}, the robot uses an inspection controller ρ_{inspect} to navigate the robot to the target object within a radius c and trigger the finish signal u^{f}. In summary, the local planner serves as a finite state controller to generate robot policy if πₖ=π^{l}(π^{g} (xₖ), bₖ).

The approach described herein consists of an offline initialization of the DSG 204 and RSN 202 and an online object-goal planning. Before deploying the robot for the task, the DSG 204 is generated from spatial configuration data 210 (e.g., blueprints, floor plans, 3D maps, etc.). Floor plans provide geometric and semantic information about the room/region nodes [symbol] . For the location of nodes [symbol] , the nodes are sampled uniformly across all the open space based on the floor plan to ensure full room coverage. The Euclidean distance between nodes [symbol] is then calculated and stored on the edges.

When the robot 212 is being deployed in the environment, the data 214 collected by the robot is used to update the DSG (e.g., using the DSG updating component). First, the robot self-localizes using its LIDAR-based map to the floor plan. The robot navigates in the environment and updates the traversability risks between the location nodes. The connectivity can change across deployments due to the evolving object configuration in the environment over time, which is not described in the floor plans. During the deployment and in experiments, changes in the connectivity between rooms and buildings are not considered. When the robot observes and localizes an object, a new object node is created on the first layer and connected to the nearest location node. The updated DSG 204 is used for path planning and stored for future deployments.

The RSN 202 is trained to predict object occurrences to guide the robot in searching for objects that can be found in the environment. During the deployment, when the robot receives a user query 216 that instructs the robot to inspect a target object y_{G}, the global planner 206 computes the global policy that minimizes the expected travel distance to search for y_{G} through the rooms or regions in the environment. Finally, the local finite state controller 208 selects a control policy for the robot based on the estimated belief of the target object. As the robot observes the environment, it recomputes its global and local policy and saves the DSG 204 and RSN 202 for future deployments.

The RSN 202 is a compact semantic information representation for object-goal navigation. The RSN 202 is trained using common-sense knowledge to estimate the probability of the object's presence in various room types. The RSN 202 is specifically designed to extract semantic relationship knowledge from LLMs, as in industrial inspection scenarios, the robot typically lacks remote access to LLMs and has limited computational resources to host large models onboard.

The RSN consists of a sequence of three networks that receive the target object semantic class

$${y}_{G}^{l}$$

in text and output the probability of finding y_{G} across rooms P(y_{G}) [symbol] (y_{G}, [symbol] ). The first network 218 is a pre-trained text encoder that maps the target object class to a text embedding 220. A text embedding model or vision language embedding model that captures semantic similarity between objects can be used as the text encoder 218. A small BGE embedding model may be used. The text embedding 220 is then passed through a multi-layer perceptron (MLP) 222 that estimates the probability of finding the target object in every room type. The final network 224 is a Bayesian network that estimates the probability P(y_{G}) of finding the target object in every room [symbol] given the MLP estimates and past observations.

In various implementations, the MLP 222 may have three hidden layers although any suitable number of layers and layer types may be used. The MLP 222 outputs two types of information: the probability of finding an object in each room type and the probability of finding an object without searching the room carefully [symbol] ^{search}. The room types include a plurality of predefined room types. In various implementations, the room types comprise a common semantic class of rooms in indoor environments which may be taken from a predefined dataset, such as the Matterport3D dataset. The probability of finding an object without a local room search estimates how easy it is to find an object y_{G} when entering a room for the first time. More prominent and highly visible objects, such as refrigerators and fire extinguishers, have a higher value compared to smaller objects that are possibly placed in cluttered spaces, such as coffee mugs or laptops.

The MLP 222 may be trained using object names that are typically queried for object-goal navigation in home and urban buildings. The MLP 222 is trained to enable the RSN 202 to predict semantic relationships for semantically similar object names outside the training data. An LLM 226, such as GPT-4, may be used to generate a list of objects to use as training data. Then, for the given object list, the LLM 226 may be queried to estimate the probability of finding the object in every room type and the probability of finding an object without a careful room search. The MLP 222 is trained using the dataset created by the LLM 226 and text embeddings of the object names. The text embedding help the MLP 222 estimate the probability of objects outside of the training data because similar objects are located close to each other in the embedding space.

The Bayesian network 224 updates the probability P(y_{G}) when there are new environmental observations. Updating P(y_{G}) moves the probability closer to the true distribution of the object placements in the environment. While the MLP 222 trained using internet data can help to initially estimate the probability P(y_{G}), updating P(y_{G}) is important because the environment has variations in object placement. A naive Bayes model may be used as conditional independence of the object observation can be assumed on every room in the environment. The root node of the model is the prior probability distribution of the target object y_{G} from the previous inference step. The evidence node of the model is a binary value of whether the robot sees the target object in every room after a local search. This conditional distribution is estimated from the MLP. Exact inference of the probability P(y_{G}) is performed using the rule of conditional probability and marginalization.

Extension to open vocabulary prediction: The RSN 202 is designed to encode semantic relationships in a model that can be deployed on the robot with limited computational resources and no remote access to LLMs. The RSN is trained to predict P(y_{G}) of objects that are expected to be queried for environment-specific applications and semantically similar objects from the training dataset. Given access to an LLM on the robot or remotely, the RSN 202 can be adapted to an open vocabulary setting by replacing the text encoder 218 and MLP network 222 with a direct query to LLMs.

Given the DSG 204 and the RSN 202, the semantic-guided global planning problem may be solved through the MDP formulation. The state space [symbol] and action space [symbol] are extracted from the set of room nodes [symbol] in the DSG. To specify the transition probabilities P, the transition probabilities is first set to reach the goal state P( [symbol] ₖ₊₁= [symbol] ^{G}| [symbol] ₖ, [symbol] ₖ) by querying the RSN. The transition between rooms is deterministic since the DSG [symbol] is a connected graph. Then the transition probabilities can be set to reach a new room after taking action [symbol] ^{move} and staying in the same room after taking the action [symbol] ^{search} as 1−P( [symbol] ₖ₊₁= [symbol] ^{G}|Xₖ, [symbol] ₖ. To specify the cost function C, the shortest travel distance to visit rooms using A* search on the DSG is computed and the total distance to visit location nodes in every room is computed. Given that the room connectivity is assumed not to change during the run, the cost function C can be computed offline and stored as a look-up table for planning. The cost function can be recomputed during the run if changing room connectivity is true. The cost function can be recomputed between global planning computations.

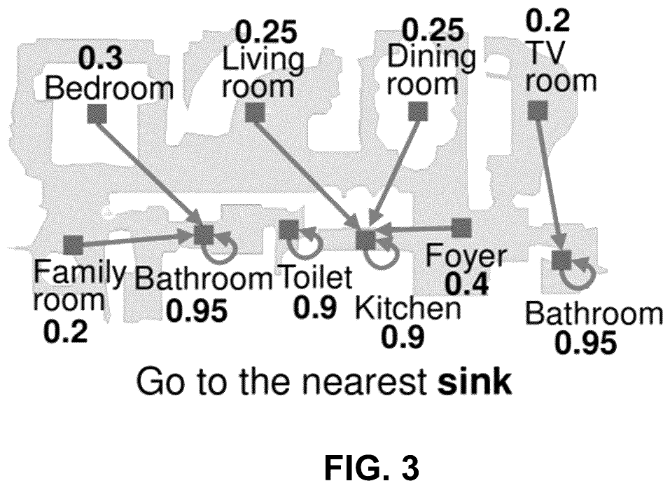

The MDP planning problem in Equation 2 is solved in real-time on the robot. Given a relatively small state and action space (| [symbol] |<100 and | [symbol] |<200), value iteration can be used to compute the optimal policy π^{G}. When querying a global action [symbol] from π^{g}(xₖ), the robot chooses the action associated with the state of the closest room node from the robot pose. FIG. 3 shows a visualization of a global search policy based on the instruction “Go to the nearest sink.”. In FIG. 3, the RSN predicts the probability of finding a sink in every room. The policy computes the best action from each room to locate the nearest sink. The circular arrow represents the local search.

Global policy π^{G} is updated in a receding horizon manner. After executing a global action [symbol] ᵢ, the robot will have an updated belief of the target object distribution given a new observation P(y_{G}|zₖ₊₁). The transition probabilities P may then be updated and a new global policy π^{G} can be determined.

The local finite state controller 208 is comprised of three different controllers that execute the global policy π^{g}, search, and navigate to the object, respectively. These controllers include a global search controller ρₙₐᵥ 228, an active semantic search controller ρ_{search} 230, and an object inspection controller ρ_{inspect} 232. The SB2G framework 200 described below may be used to implement and define the controller switching.

Global search controller ρₙₐᵥ 228 computes a robot policy according to the global policy π⁹ (xₖ). If the global action is to move to a new room [symbol] ^{move}, the controller 228 computes the shortest path to the room on the graph and passes the path to a risk-aware MPC controller that computes a robot trajectory. If the global action is to search the current room, the controller 228 plans a coverage path that explores the obstacle-free area in the room and passes the path to the MPC controller. Active semantic search controller ρ_{search} 230 plans a path that maximizes the information gain of observing a potential target object. The active semantic search algorithm described below may be used. Object inspection controller ρ_{inspect} 232 computes a policy to move the robot as close as possible to the detected target object. The controller 232 chooses a target robot pose on an obstacle-free area closest to the target object.

The robot policy, path, and/or target pose are given to the robot controller 212 which causes the robot to perform the action specified by the robot policy, search path, and/or target pose. In various implementations, the robot controller 212 is implemented as an MPC controller.

The performance of the SEEK framework was evaluated in representative simulations and on hardware. The performance of the SEEK framework was first evaluated against other methods in a Habitat simulator. Then, the performance of SEEK was analyzed in a representative office environment in the ROS Gazebo simulator. Finally, SEEK was deployed on a legged robot performing real-world inspection scenarios in an office building. The performance of SEEK in the Habitat simulator was evaluated using the Matterport3D dataset. The RSN was not trained with any data from the dataset. The Matterport3D dataset provides a hierarchical scene configuration that was used to build the DSG. The robot was tasked to navigate to the closest object instance. Five scenes and ten different objects from the Matterport3D dataset were sampled. The simulations were performed on a laptop with an Intel i9-11950H CPU.

SEEK was evaluated against four approaches: (i) semantic utility, (2) GPT-4 planner, (3) room coverage, and (4) random policy. The semantic utility method selects a room that has the highest semantic utility. For the tests, semantic utility implemented frontier selection for the room selection problem. The robot chooses an unvisited room with the highest utility [symbol] _{i,sem}=1/(distₛₑₘ(y_{G},vᵢ)·dist(xₖ,vᵢ)). The semantic distance distₛₑₘ(y_{G},vᵢ) is the distance between the target object and the room name in the word embedding space. The intuition behind using semantic distance is that objects and room names that are more semantically related have closer distances in the embedding space, reflecting the likelihood that the object is commonly found in that room. BERT embeddings were used. The geodetic distance dist(xₖ,vᵢ) is the shortest path length from the current robot position to the centroid of the room.

GPT-4 planner provides the sequence of action for the robot based on the given context in the query. The exact same information that was provided to the RSN and global planner was provided to the GPT-4 planner in text, including the list of rooms, path lengths between rooms, robot state, action space, and inspection objective. The Chain-of-Thought prompting technique was used to guide the robot to reason where to find the object.

The room coverage method selects the next room greedily based on the path distance between the current robot pose to unvisited rooms. This method serves as a baseline of an object search method without semantic guidance. The random policy method chooses a sequence of rooms to be searched at random. The random baseline is used to evaluate the benefit of other approaches. For every method, 50 simulations were run in the Matterport3D dataset. To assess the benefit of relational semantic knowledge, in this experiment, the SEEK framework does not remember/use the target object location and any information from previous runs.

The performance of SEEK was evaluated with the SPL (Success weighted by Path Length) metric, a standard metric to measure object-goal navigation performance. The SPL is defined as:

$$SPL = \frac{1}{{N}_{run}} {\sum }_{i = 1}^{{N}_{run}} {S}_{i} \frac{l}{max ( {p}_{i} , l )} . \qquad ( 10 )$$

In this definition, Sᵢ ∈{0,1} denotes whether the i-th run was successful (i.e., 1) or not (i.e., 0), lᵢ represents the length of the shortest possible path to the nearest instance of the target object, and pᵢ indicates the length of the path actually taken by the agent during the i-th run. In the experiments, given the target object's presence in the environment and unlimited simulation time, all methods are capable of locating the target object. This is because the action space of each method enables the robot to visit and search every room. Therefore, in these conditions, Sᵢ is always equal to 1.

Table 1 presents the performance of various methods at locating fixed objects (e.g., bed, sink) and movable objects (e.g., clothes, towel). The table shows the mean and standard deviation of the Success weighted by inverse path length (SPL). Results are separated into two categories: Fixed Objects and Movable Objects, to demonstrate the effectiveness of different methods on different types of objects. SEEK outperforms other methods in both object categories. SEEK is significantly better at locating fixed objects, which can be attributed to their distinct association with specific room types. In contrast, searching for movable objects is relatively more challenging as they can be found in various rooms.

TABLE 1
Global planning results

SPL Mean (Std. Deviation)

| METHOD | Fixed Objects | Movable Objects |
|---|---|---|
| SEEK | 0.96 (0.12) | 0.84 (0.23) |
| Semantic Utility | 0.74 (0.27) | 0.70 (0.27) |
| GPT-4 Planner | 0.84 (0.26) | 0.81 (0.23) |
| Room Coverage | 0.77 (0.25) | 0.65 (0.27) |
| Random Policy | 0.65 (0.35) | 0.68 (0.32) |

GPT-4 Planner ranks second in simulation performance. It demonstrates competent reasoning in object search tasks. However, its limitations become apparent in probabilistic and spatial reasoning. GPT-4 Planner's rule-based approach struggles with probabilistic reasoning, which is important in scenarios with uncertainties about the environment and object locations. For example, when the robot is tasked with finding clothes, the planner moves the robot to the nearest bathroom instead of prioritizing the bedroom and bathroom, which are slightly farther away but jointly have a higher probability of containing clothes. This indicates a lack of inherent understanding of spatial relationships in GPT-4 Planner's reasoning.

### SB2G Framework.

The semantic-based robot inspection in unknown environment problem is defined as follows: Let xₖ∈X denote the robot state and yₖ∈Y denote the geo-semantic state of objects in an environment being searched. The robot state

$${x}_{k} := ( {x}_{k}^{p} , {x}_{k}^{q} , {x}_{k}^{a} )$$

consists of the position

$${x}_{k}^{p} ∈ {ℝ}^{3} ,$$

orientation

$${x}_{k}^{q} ∈ SO ( 3 ) ,$$

and internal state information

$${x}_{k}^{p}$$

(e.g., the robot's locomotion and sensor status). The semantic state yₖ represents the set of N objects yₖ={y_{1,k}, . . . y_{N,k}}. Each object state

$${y}_{i , k} := ( {y}_{i}^{p} , {y}_{i}^{q} , {y}_{i}^{l} , {y}_{i , k}^{a} )$$

captures the position

$${y}_{i}^{p} , orientation {y}_{i}^{q} , semantic class {y}_{i}^{l} ,$$

and affordance status

$${y}_{i , k}^{a}$$

of an object. The objects' poses and classes are assumed to be static, which enables the subscript k to be omitted. In this example, the framework identifies and annotates objects of specific classes such as fire extinguishers, doors, and stairs, also indicating their status like ‘to be inspected’ or ‘to be ascended’.

Robot control and transition model: Let uₖ ∈U denote the control input, where the d_{U}-dimensional control space U⊆ [symbol] ^{d}^{_{U}} accommodates various types of control inputs for both navigation and semantic inspection tasks. Examples of navigation control inputs include velocity commands and velocity limits, as well as robot locomotion modes. For semantic inspection tasks, control inputs may consist of actions like pitching the robot up or down to find objects, or activating sensing and data capture modules. The state evolution model (xₖ₊₁, yₖ₊₁)=f(xₖ, yₖ, uₖ, wₖ) defines how the robot and object geo-semantic states evolve as functions of both robot control inputs and process noise wₖ.

Geo-semantic observation variable and model: When the robot operates in unknown environment, the state of the semantic objects yₖ is partially observable to the robot. If an object y_{i,k} is visible from the current robot state xₖ, the robot can obtain a geo-semantic observation zₖ∈U. The observation

$${z}_{k} := ( {z}_{k}^{p} , {z}_{k}^{q} , {z}_{k}^{l} , {z}_{k}^{s} )$$

consists of the object's measured position

$${z}_{k}^{p} , orientation {z}_{k}^{q} , detected class {z}_{k}^{l} ,$$

and detection confidence score

$${z}_{k}^{s} .$$

The observation model zₖ=h(xₖ, yₖ, vₖ) encodes the relationship between (xₖ,yₖ) and zₖ where vₖ is the observation noise.

Belief: A belief state bₖ∈B is a conditional probability distribution bₖ:=p(xₖ, y| [symbol] ) over robot and objects' geo-semantic states given the history of observations and control inputs up to time k. Belief bₖ is used as the basis for decision-making. The belief bₖ is updated using a belief evolution model bₖ₊₁=τ(bₖ,uₖ, zₖ₊₁) which can be computed recursively as follows:

$${b}_{k + 1} = α p ( {z}_{k + 1} \vert {x}_{k + 1} , {y}_{k + 1} ) \times \int \int p ( {x}_{k + 1} , {y}_{k + 1} \vert {x}_{k} , {y}_{k} , {u}_{k )} {b}_{k} {dx}_{k} {dy}_{k} , \qquad ( 2 )$$

where αserves as a normalization constant.

Policy, reward, and cost: Given the current belief bₖ, the robot generates action according to a policy uₖ=π(bₖ), with π∈Π. To find an optimal policy for the robot, semantic task rewards rₗ(bₖ, uₖ), ∇l∈L, and costs c(bₖ, uₖ) are defined. The robot gets a reward when it successfully inspects objects, climbs stairs, or enters doors, while the costs include distance traveled by the robot or operation time.

Given the preceding descriptions and formulations, the problem can be formally defined as follows:

Problem 2 (Semantic-based robotics inspection in unknown environment): Given a current belief b₀ and semantic object tasks defined by rₗ(bₖ, uₖ), find an optimal inspection policy if where:

$$π = {arg max}_{π ∈ Π} 𝔼 [ {\sum }_{k = 0}^{∞} {\sum }_{l ∈ L} {r}_{l} ( {b}_{k} , π ( {b}_{k} ) ) - c ( {b}_{k} , π ( {b}_{k} ) ) ] , s . t . {b}_{k + 1} = τ , ( {b}_{k} , π ( {b}_{k} ) , {z}_{k} ) , {z}_{k} ∼ p ( {z}_{k} \vert {x}_{k} , {y}_{k} ) , {x}_{k + 1} = f ( {x}_{k} , {y}_{k} , π ( {b}_{k} ) , {w}_{k} ) . \qquad ( 3 )$$

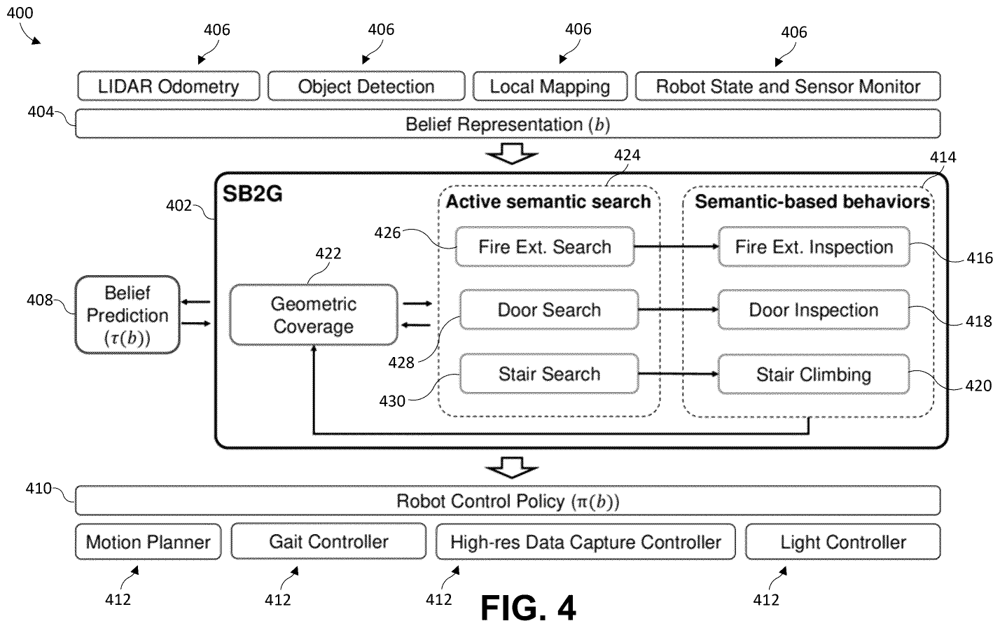

To solve Problem 2, the SB2G framework is provided. An example implementation of an SB2G framework 400 is shown in FIG. 4. The SB2G framework 400 includes a SB2G component 402 which gathers belief representation (i.e. state) b 404 from various perception modules 406. At a high level, the SB2G component 402 selects a behavior based on belief state b 404 and uses belief prediction r 408 to compute a robot control policy π 410. The policy 410 is used as the basis for controlling robot actions 412, such as locomotion, high-resolution data capture, and lighting.

In SB2G, nodes represent distinct robot behaviors, and edges denote transition conditions to switch between behaviors. This framework is similar to finite state machines. SB2G enables the robot to efficiently navigate and inspect the environment by combining semantic understanding, geo-semantic state uncertainty, and behavioral decision making.

Belief representation and Prediction: Robot belief and semantic object belief are represented separately. The belief of robot pose p(x^{p},x^{q}) is represented as a Gaussian distribution. A LIDAR-based odometry method may be used to estimate p(x^{p}, x^{q}). Meanwhile, the semantic object belief p(y) is represented as an array of the belief of detected object p(yᵢ). The object pose belief

$$p ( {y}_{i}^{p} , {y}_{i}^{q} )$$

is represented as a Gaussian distribution and estimated with an object-based localization using LIDAR and a color camera. The object class belief

$$p ( {y}_{i}^{l} )$$

is represented as a categorical distribution with ILI categories. The class belief is estimated using an object detection system, such as YOLO (“You Only Look Once”). Both the robot's other internal states (e.g., locomotion gaits, robot's sensor status), xa, and the object's inspection status, y^{α}, are known to the robot.

Observation model: The semantic observation of an object yᵢ can be derived from a detection model and observation likelihood. It is assumed that the robot can distinguish semantic observation z from every object yᵢ.

The detection model quantifies the likelihood of the robot x detecting an object yᵢ. The detection probability for an object within the robot's field of view, FoV(x), is modeled using the following decaying function based on distance:

$${p}_{d} ( {y}_{i} , x ) := \{ \begin{matrix}{p}_{0 , i}^{exp [ - \frac{\vert {m}_{0 , i} - d ( x , {y}_{i} ) \vert}{{v}_{0 , i}} \}} & if {y}_{i}^{p} ∈ FoV ( x ) \\ 0 & otherwise\end{matrix} , \qquad ( 4 )$$

where d(x,yᵢ) denotes distance between x and yᵢ. The constants p_{0,i}, m_{0,i}, v_{0,i} specify the base detection probability, optimal detection distance, and the decay rate, respectively.

When the robot detects an object, the observation likelihood models the probability of obtaining the observation z. Since z is conditioned on the object state yᵢ, the observation measurements can be assumed to be independent of each other. The pose measurement likelihood p_{pq}(z^{p},z^{p}|yᵢ,x) is modeled as a Gaussian distribution with mean

$$( {y}_{i}^{p} , {y}_{i}^{q} ) and convariance ( {\sum }_{i}^{p} , {\sum }_{i}^{q} ) .$$

From experiments, it can be observed that the noise of pose measurement and detection score increases with the distance to object d(x,yᵢ) and true bearing angle β(yᵢ, x). The noise also depends on the object class

$${y}_{i}^{l} . ( {\sum }_{i}^{p} , {\sum }_{i}^{q} )$$

can be modeled with the following equations:

$${\sum }_{i}^{p} = diag ( {( {σ}_{p , d} d ( x , {y}_{i} ) + {σ}_{p , β} β ( {y}_{i} , x ) + {σ}_{p , l} γ ( {y}_{i}^{l} ) )}^{2} , {\sum }_{i}^{q} = diag ( {( {σ}_{q , d} d ( x , {y}_{i} ) + {σ}_{q , β} β ( {y}_{i} , x ) + {σ}_{q , l} γ ( {y}_{i}^{l} ) )}^{2} . \qquad ( 5 )$$

The constant σ and function γ are learned from data.

The measurement of semantic class z^{l} can be assumed to be independent of x due to the scale and orientation invariance of the object detection module. The semantic class likelihood

$${p}_{l} ( {z}^{l} \vert {y}_{i}^{l} )$$

is derived from the confusion matrix of the object detector and can be learned from data.

Meanwhile, experimentally it is observed that the score measurement zs decreases with d(yᵢ, x) which can be modeled with the following equation:

$${p}_{s} ( {z}^{s} \vert {y}_{i}^{l} , x ) = {p}_{l} exp \{ - \frac{\vert {m}_{l} - d ( x , {y}_{i} ) \vert}{{v}_{l}} \} . \qquad ( 6 )$$

Finally, the observation likelihood can be defined as

$${p}_{z} ( z \vert {y}_{i} , x ) = {p}_{pq} ( {z}^{p} , {z}^{q} \vert {y}_{i} , x ) {p}_{l} ( {z}^{l} \vert {y}_{i}^{l} ) {p}_{s} ( {z}^{s} \vert {y}_{i}^{l} , x ) . \qquad ( 7 )$$

State transition model: For the transition model of the robot pose

$${p}_{x} ( {x}_{k + 1}^{p} , {x}_{k + 1}^{q} \vert {x}_{k} ) ,$$

a unicycle model can be used that captures longitudinal and lateral velocities of the system, which are characteristics often found in legged robots. Deterministic transitions for other state variables x^{α}, such as the robot's locomotion mode and the sensor in use, may be assumed.

Belief prediction model: Based on the state transition and observation models, the belief transition function τ is formulated according to Equation 3.

Referring again to FIG. 4, semantic-based behaviors 414 enable a robot to perform specific semantic tasks. When a semantic-based behavior is triggered in SB2G, it executes control actions according to a policy πⁱ⁻¹ to accomplish a specific task i for a particular semantic class l. To gain rewards rₗ for the task, the robot needs to execute the behavior in a certain range of the belief state B^{l}. For example, B^{l} can be defined as a set of beliefs when the estimated object location p(y^{P}) is in close proximity to the robot with a low uncertainty and the semantic class confidence p(y^{l}) is high.

The design of a semantic-based behavior policy depends on the task. In this example, three different types of behavior are used to enable a complete autonomous inspection: object inspection, stair climbing, and geometric coverage.

Object inspection: This behavior enables the robot to perform a close-range inspection task. In this example, fire extinguisher inspections 416 and door inspections 418 are used. The inspections involve controlling the robot according to a policy π^{inspect-FE} for inspecting fire extinguishers or π^{inspect-Door} for inspecting doors. For fire extinguisher inspection 416, the robot needs to read the pressure gauge. For door inspection 418, the robot needs to check whether the door is closed or open and measure the dimension of the door. The robot achieves its inspection objective when it successfully measures the correct object. Performing an incorrect inspection in the absence of the correct object will waste operational time.

Stair climbing: The stair climbing behavior 420 is important for autonomous inspection in multi-level environments. The stair climbing control policy π^{climb-Stairs} is different between mobility system. For legged robots, the robot first needs to estimate the pose of the stair in the proximity of the robot using dense point cloud data. After positioning the robot in front of the stairs, the robot needs to switch its gait locomotion policy to a stair climbing mode before traversing the stairs. Successful stair climbing expands the robot's inspection capabilities considerably. However, failed execution due to incorrect stair localization can be catastrophic.

Geometric coverage: When the robot is not performing semantic-based behaviors 414 and active semantic search 424, the robot may explore the unknown environment using a geometric coverage behavior 422. In various implementations, a coverage planning algorithm π^{coverage} is defined for the robot to use to explore the obstacle-free space in the environment. The policy plans robot trajectory to sweep the free space with the sensor footprint. Geometric coverage 422 ensures the robot to cover the unknown environment efficiently while searching for inspection targets and stairs.

To execute the semantic-based behaviors 414 successfully, the robot needs to have a low belief uncertainty about the object state. However, in real world operations, achieving high-confidence estimates of the object state is challenging due to perceptual uncertainties To address this challenge, an active semantic search behavior 424 is provided to guide the robot to perform actions to increase the confidence of the belief. In the example of FIG. 4, active semantic search behaviors 424 include fire extinguisher search 426, door search 428, and stair search 430.

When active semantic search is triggered, the robot executes a policy ρ^{l} to reduce the belief uncertainty of yᵢ for the expected class l. The policy ρ^{l} is parameterized by the object class l to account for the varying strategies required for locating different types of objects.

The policy ρ^{l} drives the current belief b to a set of target beliefs B^{target}. The belief target for policy ρ^{l} is a union of two belief set, B^{target}=B^{l} ∪B^{α}. The first set B^{l} represents beliefs with high confidence in the semantic object yᵢ. The second set B^{α} represents the alternative outcome of the semantic search where there is not high confidence in

$${y}_{i}^{l} .$$

To drive the belief to B^{target} the entropy [symbol] (y_{i,0:T}|z_{1:T},b₀) of the target object yᵢ conditioned over the future observations is used. The conditional entropy is an appropriate objective function because it quantifies the amount of information needed to describe the belief of the target object yᵢ given the probabilistic value of semantic observation z. The active semantic search behavior solves the following problem:

Problem 3 (Active semantic search): Given a current belief b₀, the target object belief p(yᵢ) with expected class l, compute a policy p^{l}:

$${ρ}_{0 : T}^{l} ( p ( {y}_{i} ) ) = arg {min}_{{ρ}_{0 : T}} ℍ ( {y}_{i : 0 T} \vert {z}_{1 : T} , {b}_{0} ) , s . t . {b}_{k + 1} = τ , ( {b}_{k} , π ( {b}_{k} ) , {z}_{k} ) , {z}_{k} ∼ p ( {z}_{k} \vert {x}_{k} , {y}_{k} ) , {x}_{k + 1} = f ( {x}_{k} , {y}_{k} , π ( {b}_{k} ) , {w}_{k} ) . \qquad ( 8 )$$

The policy ρ^{l} is executed until the belief b reaches B^{target}.

To reduce the computational cost of solving Problem 3 in real-time on the robot, two assumptions are made. First, the transition model is assumed to be deterministic (w=0) because the transition noise of the robot pose over a short horizon is small enough for the planning problem. Second, a sparse sampling method is used to reduce the search branching factor of the robot's action space. This approach narrows the search on identifying the next poses that are both situated in obstacle-free zones and contribute to entropy reduction.

The active semantic search policy is computed by performing a branch and bound search in a receding horizon manner. At every time step, an optimal policy

$${ρ}_{0 : T}^{l} ( p ( {y}_{i} ) )$$

is solved and only

$${ρ}_{0}^{l}$$

is executed. After the belief is updated with the actual z, a new policy ρ^{l} is computed.

Behavior Transition in SB2G: In SB2G, behavior transitions are represented by the graph edges e∈E. The trigger condition to transition between behaviors is governed by the SB2G transition policy π^{t}: N×B→N. Then, based on the selected behavior, the SB2G policy π^{g} returns a control policy for the robot π=π^{g} (nₖ, bₖ).

Trigger condition: There are four approaches to designing the trigger condition in SB2G. First, the edges that transition from active semantic search behaviors to semantic-based behaviors π^{i-l} are considered. The trigger condition for these edges occurs when the belief bₖ is in the set of beliefs B^{l} that can ensure the robot performs the semantic-based behaviors successfully. Second, edges transitioning from active semantic search behaviors to geometric coverage are triggered when bₖ ∈B^{α}. Next, the edges that go from geometric coverage to active semantic search behaviors are considered. Here, the robot switches to active semantic search if it detects an uninspected object yᵢ and the current belief is in B^{search-l}. The set B^{search-l} consists of beliefs having low-confidence object probabilities p(yᵢ), enabling the active search to effectively reduce the uncertainty. Finally, transitions from semantic-based behaviors to geometric coverage are triggered when the robot has successfully completed its semantic tasks.

Semantic-based planning with SB2G: The process of performing robotic inspection using SB2G until a terminal condition B^{terminal} (e.g., inspected N objects) is shown in Algorithm 1.

| Algorithm 1 Planning with SB2 | |
|---|---|
| Require: b₀, SB2G = (N, E), π^{g}, B^{terminal} | |
| 1: | bₖ ← b₀ |
| 2: | nₖ ←‘geometric coverage’ |
| 3: | while bₖ [symbol] B^{terminal} do |
| 4: | Select a SB2G behavior nₖ₊₁ ← π^{t} (nₖ, bₖ) |
| 5: | Compute a control policy πₖ ← π^{g} (n_{k+1,} bₖ) |
| 6: | Apply the action uₖ = πₖ(bₖ) to the system |
| 7: | Observe the actual observation zₖ₊₁ |
| 8: | Update the belief bₖ₊₁ ← τ(bₖ, uₖ, zₖ₊₁) |
| 9: | end while |

The SB2G framework for autonomous inspection was evaluated in simulation and real-world environments. Simulations were performed in a representative office environment with a size of 38×20×10 m. Simulations were carried out using the Gazebo simulator with a Boston Dynamics' Spot model. Ten semantic objects comprised of fire extinguishers, closed doors, and stairs were placed in the environment, as shown in FIG. 3. The robot is tasked to perform object inspections. The environment map and the true state of the objects are unknown to the robot. The parameters used for the experiments are summarized in Table 2. The simulations were performed on a laptop with an Intel i9-11950H CPU.

TABLE 2
SB2G parameters used in the experiments.

| Parameter | Value |
|---|---|
| B^{search-l}, ∀l ∈ L | $p ( {y}_{i}^{l} ) > 0.7 and {\sum }_{i}^{p} < 5 m$ |
| B^{l}, ∀l ∈ L | $p ( {y}_{i}^{l} ) > 0.9 , {\sum }_{i}^{p} < 1 m , and 𝔼 [ d ( x , {y}_{i} ) ] < 2.5 m$ |
| T | 8 s |

SB2G was compared with two methods for the simulation: (1) geometric coverage and (2) coverage and inspection. 1. Geometric coverage only perform coverage π^{coverage} to explore uncovered free space in the environment. A rollout-based coverage planning method was used in the simulation which predicts future coverage using a sensor model similar to the sensor setup for the robot using SB2G. The coverage and inspection method performs coverage π^{coverage} and object inspection (π^{inspect-FE}, π^{inspect-Door}, and π^{inspect-Stair}) without the active semantic search. In this case, the robot switches to object inspection behavior when the robot has high confidence in performing the inspection (b E B^{l}).

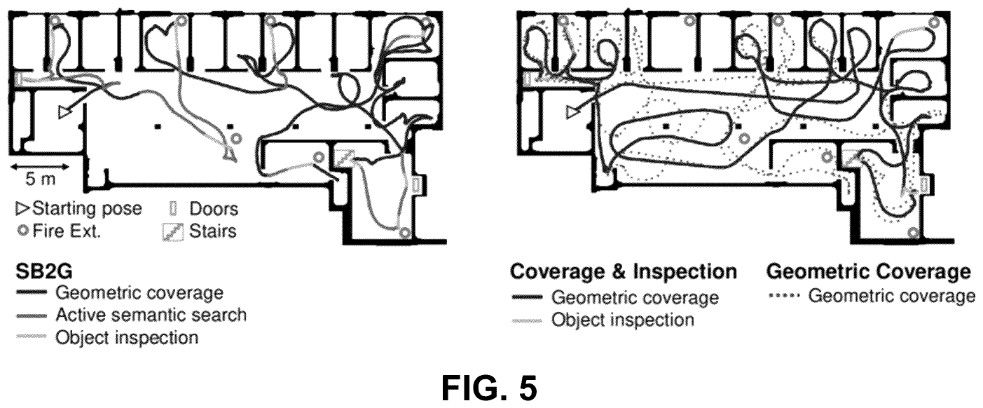

For each method, 5 simulations were ran starting from the same location for 700 s. FIG. 5 shows the comparison of the robot path and the behavior transition. The ‘coverage and inspection’ method inspected fewer objects than SB2G. This occurs because the robot rarely approaches the inspection targets closely to get reliable semantic observations for performing inspections. Meanwhile, SB2G generates a more efficient path by guiding the robot towards inspection targets by using the active semantic search. The active search policy ρ^{l} directs the robot towards areas where it can gather better semantic measurements.

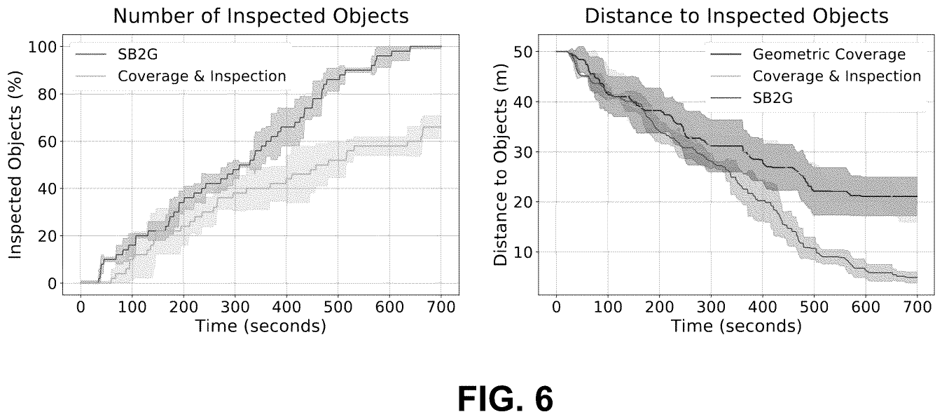

Inspection performance is shown in FIG. 6. The SB2G method outperforms the baseline methods considerably in the number of inspections over time. In all methods, the geometric coverage behavior helps the robot in rapidly approaching inspection targets, especially at the beginning of the run when semantic observations are not yet available. However, without the active semantic search, the robot often fails to approach inspection targets closely enough, and consequently, is unable to execute inspection behaviors.

SB2G was tested and deployed in various office buildings in California, USA. The experiment was conducted using a Boston Dynamics Spot robot. The robot is equipped with a LIDAR and 3 cameras for navigation and semantic observation. A YOLO-based model was used to detect fire extinguishers and a point cloud-based model for stair detection. The detection model was not trained using the data gathered in the office. Two fire extinguishers were randomly placed in the environment. The robot did not have prior knowledge of either the office map or the objects' true locations.

To evaluate the efficiency of SB2G in real-world inspections, robot behavior based on SB2G was compared with robot behavior manually operated by a human. The human operator lacked prior knowledge of the object locations. The experiment was repeated five times, each time with different object locations. Each run lasted for 5 minutes or until two objects had been inspected.

Using the SB2G framework, the robot was able to autonomously inspect fire extinguishers and climb the stairs. Despite numerous false-positive detection, the SB2G method effectively located inspection targets by actively reducing semantic belief uncertainty. The robot accurately switched between different SB2G behaviors to accomplish a fully autonomous inspection task.

The comparison between the SB2G approach and a human-controlled robot is summarized in FIGS. 5 and 6. Qualitatively, the SB2G approach and the human operator produced similar inspection orders and paths. The human-controlled robot performs inspections more quickly and with less travel distance. The primary reason for this efficiency is that humans can more easily identify inspection targets, allowing for more direct paths and quicker inspections. Although the human operator lacked prior knowledge of the office map, the intuitive understanding of potential room layouts allows the operator to search rooms efficiently for the objects. These findings can serve as guidelines for the development of more efficient and semantically aware behaviors.

In summary, the SB2G framework enables semantic-aware autonomous robotic inspection in uncertain and unknown environments. SB2G uses semantic information to compute a control policy that guides robots through various inspection tasks. To enhance both the efficiency and accuracy of inspections, SB2G utilizes semantic belief uncertainty during planning and proactively mitigates this uncertainty before task execution. Through simulations and real-world experiments, the SB2G approach has demonstrated the ability to achieve more efficient inspection behaviors that is comparable to human-performed inspections.

SayComply: Compliant Task Planning using Retrieval-based Language Models

Problem Statement: Let s=(x,G) denote the system state that consists of a robot state x and a map of the environment G. The robot gets a query q from a user expressed in natural language. The robot can perform different tasks π∈Π, and each task policy outputs a control action for the robot π(s)=a. To complete the user query q, the robot plans a sequence of tasks π_{0:N}, where π_{N} is a task that responds back to the user on the completion of the query q. To fulfill the query, a task π is selected that maximizes p(c_{π}|s,q), the probability of completing the query by executing π. The robot can only estimate the query completion with probabilities because the robot does not have the full information about the state of the environment. Moreover, the robot should comply with the operational context provided in a database D of instructions and manuals. Hence, the robot needs to also select a task that maximizes p(y_{π}|s, q, D), the probability of being compliant with the operational context D while executing if.

Problem 4. Operation-Compliant Task Planning: The operation-compliant task planning problem may be formulated as follows: Given the robot and environment state s, a user query q, and a database of operational context D, compute a sequence of tasks π_{0:N} that maximize the probability to complete the query and comply with the operational context such that:

$${π}_{0 : N}^{*} = {arg max}_{{π}_{0 : N} ∈ Π} p ( {c}_{{π}_{0 : N}} , {y}_{{π}_{0 : N}} \vert s , q , D ) \qquad ( 9 )$$

This problem is highly challenging to solve. In order to ground robot tasks with operational compliance, a large amount of contexts in D should be considered, but the language model that estimates the query completion and compliance has a limited context window. Moreover, providing irrelevant information to the model also increases the risk of not grounding with the correct context. Thus, this problem is reformulated with two sub-problems, operational context retrieval and operational context-based task planning.

Problem 5a. Operational Context Retrieval: The operational context retrieval problem may be formulated as follows: Given s, q, and D, select and retrieve a subset of the database context D^{R} that is relevant to the query q, where the retrieved subset of database context D^{R} contains sufficient context to generate robot tasks that comply with the entire database D, and the size of the subset of database context D^{R} is less or equal to a maximum context length L of the language model:

$$find {D}^{R} \qquad ( 10 )$$

$$s . t . p ( {y}_{π} \vert s , q , {D}^{R} ) \approx p ( {y}_{π} \vert s , q , D ) , \qquad ( 11 )$$

$$\vert {D}^{R} \vert \leq L . \qquad ( 12 )$$

Problem 5b. Operational Context-based Task Planning: The operational context-based task planning problem may be formulated as follows: Given s, q, and D^{R}, compute a sequence of tasks π_{0:N} that maximizes the multi-objective function of weighted query completion probability and compliance probability such that:

$${π}_{0 : N}^{*} = {arg max}_{{π}_{0 : N} ∈ Π} p ( {c}_{{π}_{0 : N}} \vert s , q , {D}^{R} ) + β p ( {y}_{{π}_{0 : N}} \vert s , q , D ) \qquad ( 13 )$$

where β>>1 is a weight constant for the compliance probability. Note that β>>1 is used to prioritize the compliance to safe robot operations on the field to the completion of the query, which may otherwise jeopardize the compliance.

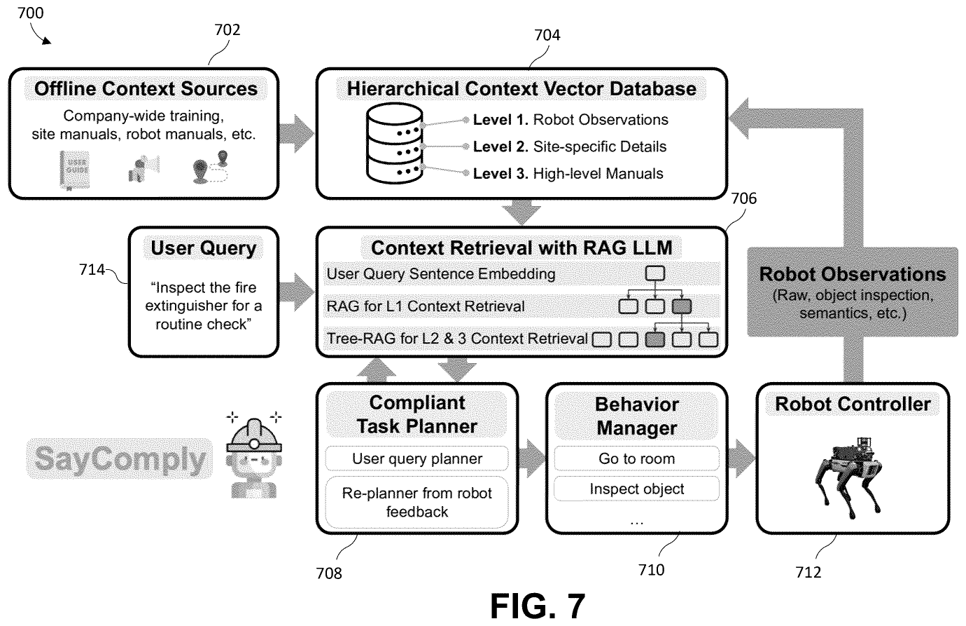

An example implementation of a SayComply framework 700 is shown in FIG. 7. The SayComply framework 700 includes offline context sources 702, a hierarchical context vector database 704, a context retrieval with RAG LLM 706, a compliant task planner 708, and a behavior manager 710.

At a high level, SayComply includes the following steps:
1) Prior to robot deployment, all the operational context sources D 702 are stored, summarized, and classified into the hierarchical context vector database 704 using RAG techniques;
2) When a robot 712 is deployed and receives a user query q 714, relevant context sources are retrieved to ensure task planning compliance using the RAG LLM 706; and
3) Finally, the compliant task planner 708 composes the best sequence of tasks π_{0:N} that completes the user query and sends the task to the behavior manager 710 which determines the behavior for the robot to use in executing the task. On every step of task execution, the planner 708 generates an updated task π based on the new robot and environment state s.

Context Source Hierarchy: To retrieve relevant information efficiently, a hierarchy of context sources 702 is built that represents all information as vector embeddings and stores the information in a database 704. These vector embeddings are used for efficient search for semantic similarity during the retrieval process. This database 704 is built offline prior to the robot deployment. Constructing the database 704 is computationally cheaper than fine-tuning an LLM.

All the relevant context sources are classified into three different levels (Context Levels 1-3) and three different context categories: environment, operation, and embodiment. Environmental context consists of information from written manuals associated with the site (e.g., floor plans or blueprints of the site). Operation context consists of written manual and verbal instructions of different procedures that can be performed by humans or robots at the site, such as inspection, surveillance, and maintenance tasks (e.g., oil and gas processing facilities inspection manual, office building maintenance manual). Embodiment context consists of information specific to the embodiment type and capabilities of the robot, such as movement, safety protocols, and operational constraints (e.g., a legged robot operation manual).

For each category, information is classified into three different levels, where this hierarchy represents a structured context approach starting from the most immediate and specific to the most general and abstract context. This structured approach enables effective retrieval from different context types and selection of relevant information given the user query.

Context Level 1, Current and past observations: Context Level 1 includes databases of past inspection data gathered by the robot or humans, and the current and history of robot state and observation. Every inspection database, robot state, and observation is summarized in a sentence to help the LLM select relevant data during context retrieval.

Context Level 2, Site-specific details: Context Level 2 comprises different instructions and guidelines to operate in a specific environment. This information comes from verbal instructions from a site expert or a brief summary coming from a longer context level 3 manual. Context level 2 can be seen as basic information and instructions that is given by a site expert to a new human operator and robots before being deployed at the site.

Context Level 3, High-level manuals: Context Level 3 comprises different documents that are used as references for human operators to ensure operational compliance. Example of context level 3 includes inspection manuals, safety document, environment blueprints, and robot operating and safety manual. Every document in this level is referenced by at least one instruction from context level 2 to help with referencing correct information during retrieval.

Context Retrieval with RAG LLM: Context retrieval is important for SayComply to ground task planning with operational compliance. Given human instruction, the RAG LLM 706 selects relevant information from the context source database 704 and passes the information to the compliant task planner 708. The LLM-based task planner 708 is constrained by the limited context length and attention of the LLM, so only a subset of the database context under a specified maximum context length is retrieved. Two different retrieval techniques may be employed.

Context level 2 and 3 retrieval: To retrieve relevant instructions and manuals from context levels 2 and 3, a tree-organized retrieval method is used. Given the user query, the query is encoded as a vector embedding and retrieve top 2 most similar entry in level 2 context sources using cosine similarity. Then, the manual most similar to the user query among the level 3 context sources is retrieved, which are pointed to by the retrieved level 2 context sources.

Context level 1 retrieval: An LLM is queried to select relevant data from context level 1. Cosine similarity is less effective to select historical and numerical data with less semantic information. A list of database titles/names along with a short description of each are provided in a query to the LLM which selects the database that can be useful to complete the query.

Compliant Task Planner: Given the user query and the context retrieved from the database, the LLM-based task planner 708 generates a sequence of robot tasks and responds to the user. The retrieved context is used to constrain the robot task space and provide all the context needed to generate plans. The planner 708 generates the best robot task that completes the user queries.

The planner is prompted with different type of robot tasks that can be recognized and executed by the robot. While the task types can be set based on robot capability and applications, for industrial inspection scenarios, the most common classes of tasks include: go-to object or rooms, search for an object, inspect (e.g., read, scan or measure) an object or a room, and so on. The prompt also includes an option to respond directly to the user when the user query violates operational compliance. A single prompt is used to generate plans in two different cases: task planning from a new user query, and task replanning from robot feedback.

Task planning from a new user query generates a sequence of tasks given a user query. The LLM is prompted to check whether the query adheres to retrieved contexts, and is queried to output the best sequence of plans for the robot that has a high-level of compliance and completes the query. It is also prompted to provide a justification of choosing the plans according to the retrieved contexts. Only the first task is sent to the robot behavior manager 710 for execution. While querying a sequence of tasks can guide the LLM to generate a complete task plan, executing only the first task allows the planner to replan based on new observations and query completion status. Subsequent plans are cached with the original user query for replanning.

Task replanning from robot feedback is triggered after the robot finishes executing a task and reports its completion status. In addition to querying LLM with the same context as the first planning from user query, the status of the previously-executed task and the cached sequence of next tasks is appended to the query. The replanner outputs an updated task sequence (either the same plan or a revised plan) and sends a new task to the robot. Replanning is performed until all tasks to fulfill the query are attempted. Finally, the planner composes an answer for the user on the completion status.

SayComply was evaluated in real-world scenarios requiring operational compliance, both in simulations and on a legged robot platform. A new set of experiments was designed based on real-world use cases.

Real world scenarios: Three distinct use cases were defined wherein a mobile robot is assisting humans in real-world operations and inspections:

1) Industrial inspection in oil & gas and manufacturing is a critical use cases where robots can help ensure continuous operation at plants, by reading gauges, capturing thermal images, and reporting anomalies for predictive maintenance.

2) Office operations and maintenance require robots to assist humans in tasks including regular maintenance checks (e.g., inspecting air conditioning systems), guiding personnel through safety and emergency procedures, and supporting daily office activities like providing office orientation, locating meeting rooms, and finding items.

3) Embodiment-aware operation in the field is related to robot task planning that needs to adhere to robot operation and safety manuals. The manual includes safety information when operating near humans, navigating challenging terrains, adjusting locomotion parameters, and providing guidelines on navigation and environmental conditions.

All relevant instructions and manuals were compiled and past observations simulated for these three use cases to build a hierarchical database of context sources that included 62 different manuals, instructions, and files.

User queries: Based on real-world scenarios, 70 different user queries were generated for the experiments. These queries represented a balanced mix of queries requiring compliance with various levels of context sources. Non-compliant user queries were also included to evaluate how effectively such queries were rejected as inappropriate requests.

Environment description: All simulations and hardware experiments are conducted within the Field AI office environment, using a high-fidelity digital twin of the space to perform extensive and parallel tests before proceeding with hardware experiments.

SayComply was evaluated in simulations in Issac Sim in an office environment. The user queries were input through a web interface, and the generated robot task is executed in the simulator by a behavior manager. In all the experiments, Open AI's GPT 4 model was used.

SayComply was evaluated against two approaches:

1) Env-Grounding. This approach only uses environmental context, including 3D scene graphs and building floor plans, to generate robot tasks without retrieving operational and embodiment contexts.

2) Top-3 RAG. This approach retrieves the 3 most relevant context sources to the user query, and is used to evaluate the benefits of the context retrieval of SayComply.

Evaluation metrics: The following metrics were used to evaluate the methods:
1) Comply: Percentage of user queries for which the method generates plans that comply with the context database D,
2) Comply & Complete: Percentage of user queries for which the method generates plans that both comply with D and fully address the user query, and
3) Context Retrieval: Percentage of user queries for which the method successfully retrieves context sources with enough information to comply with D and complete the query.

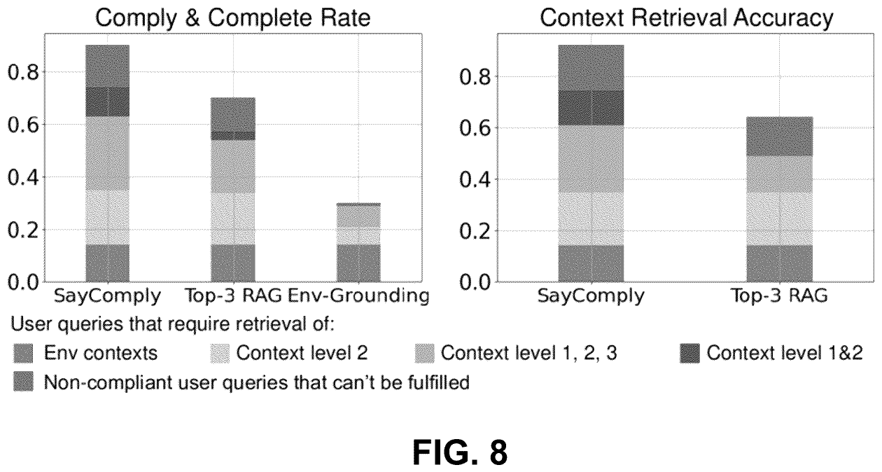

Table 3 compares the performance of all methods, and FIG. 8 examines the performance by user query category. Env-Grounding method is the least performant, as it only fulfills queries requiring environmental information and general operational context that is already available in the LLM (e.g., information on different categories of fire extinguishers). SayComply performed the best in all of the metrics. It was found that correct context sources is crucial and strongly correlated with the other metrics. It was observed that the reason the Comply & Complete and Comply rates were lower than the Context Retrieval for SayComply is that the LLM was misinterpreting the context. For example, the LLM often misinterprets tabular information in past observation data and generates non-compliant or non-complete robot tasks. For Top-3 RAG, it was observed that the Comply & Complete rate exceeds the Context Retrieval because the LLM can generate correct tasks even when the retrieved information is incomplete (e.g., only retrieving two out of three required contexts).

TABLE 3
Simulator Results

| | | Comply & | Context |
|---|---|---|---|
| Method | Comply | Complete | Retrieval |
| Env-Grounding | 32.9% | 30.0% | N/A |
| Top-3 RAG | 72.9% | 70.0% | 65.7% |
| SayComply | 91.4% | 91.4% | 92.9% |

A significant difference in the retrieval accuracy between SayComply and Top-3 RAG was observed. While both methods perform well when retrieving queries requiring level 2 context, a difference in retrieval performance occurs when retrieving queries that require level 1 and level 3 context. In contrast to shorter user instructions explicitly designed for humans or robots, retrieving level 1 and 3 context is more challenging. Level 1 context mainly consists of tabular data and report logs, which are difficult to compare using sentence embeddings in standard RAG retrieval. Meanwhile, retrieving level 3 context is more challenging as the information needed can be in different parts of the document. Using tree-RAG enables narrowing down the search based on the context level 2 retrieval. The results highlight the benefit of our tree-based RAG and LLM-based context level 1 retrieval for operational-compliant robotic task planning problems.

Hardware Results: The efficacy of SayComply on hardware was evaluated by deploying SayComply on the Boston Dynamics Spot legged robot, which is equipped with a LIDAR and a camera for navigation and semantic observation. A laptop, connected to the internet with a web-based user interface, was used for inputting user queries, sending tasks, and remote monitoring. The laptop hosts the context database, retrieval, and task generation pipelines. 15 different user queries were tested in office operations and maintenance.

Prior to the experiments, the robot site orientation was verbally given to the robot while it autonomously walked around the office. Received instructions were converted to text and associated with specific rooms where they were received. This procedure mirrored site orientations typically conducted in industrial settings, further highlighting the practicality of our approach.

In the experiments, SayComply enabled the robot to execute various user queries. The robot completed the queries requiring compliance and an understanding of different operational contexts for real-world inspection and maintenance. Users can remotely send the query, monitor the robot, and receive real-time updates from the robot via the laptop interface. SayComply's efficient context retrieval enables compliant task planning without reliance on a long-context-window that cannot be hosted on the robot or when the robot is deployed in sites without reliable internet access. These experiments demonstrate the practicality of our approach for real-world robot operation requiring operational compliance across diverse use cases.

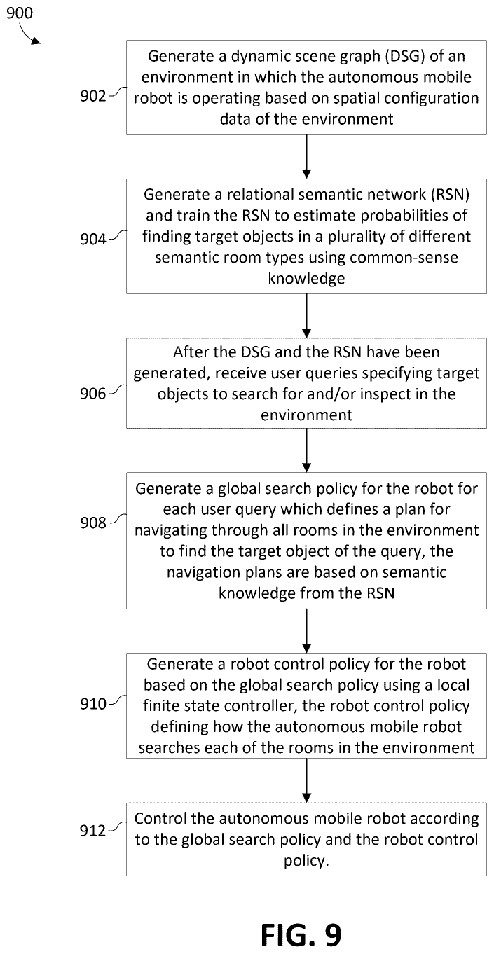

A flowchart of an example method 900 for implementing a task planning framework for object-goal navigation is shown in FIG. 9. The method begins with generating a dynamic scene graph (DSG) of an environment in which the autonomous mobile robot is operating based on spatial configuration data of the environment (block 902). In addition, a relational semantic network (RSN) is generated and trained to estimate probabilities of finding target objects in a plurality of different semantic room types using common-sense knowledge (block 904). The DSG and RSN may be generated offline. After the DSG and the RSN have been generated, user queries may then be received (block 906). The user queries specify target objects to search for and/or inspect in the environment. A global search policy is generated for the robot for each user query by a global planner (block 908). The global search policy defines a plan for navigating through all rooms in the environment to find the target object of the query. The navigation plans are based on semantic knowledge from the RSN. A robot control policy is then generated for the robot based on the global search policy using a local finite state controller (block 910). The robot control policy defines how the autonomous mobile robot searches each of the rooms in the environment. The autonomous mobile robot is then controlled to perform the search according to the global search policy and the robot control policy (block 912).

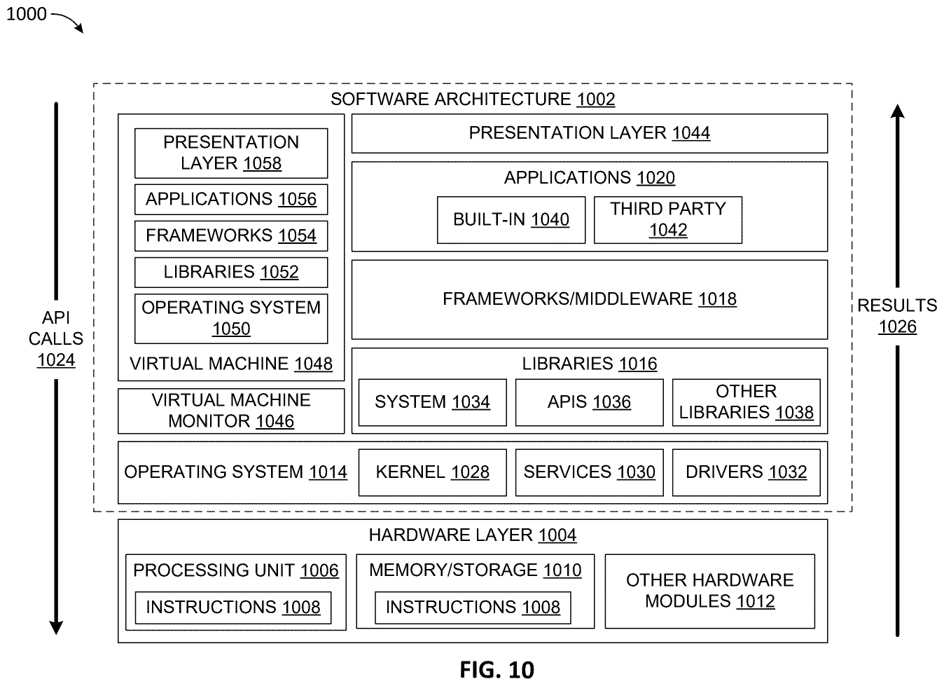

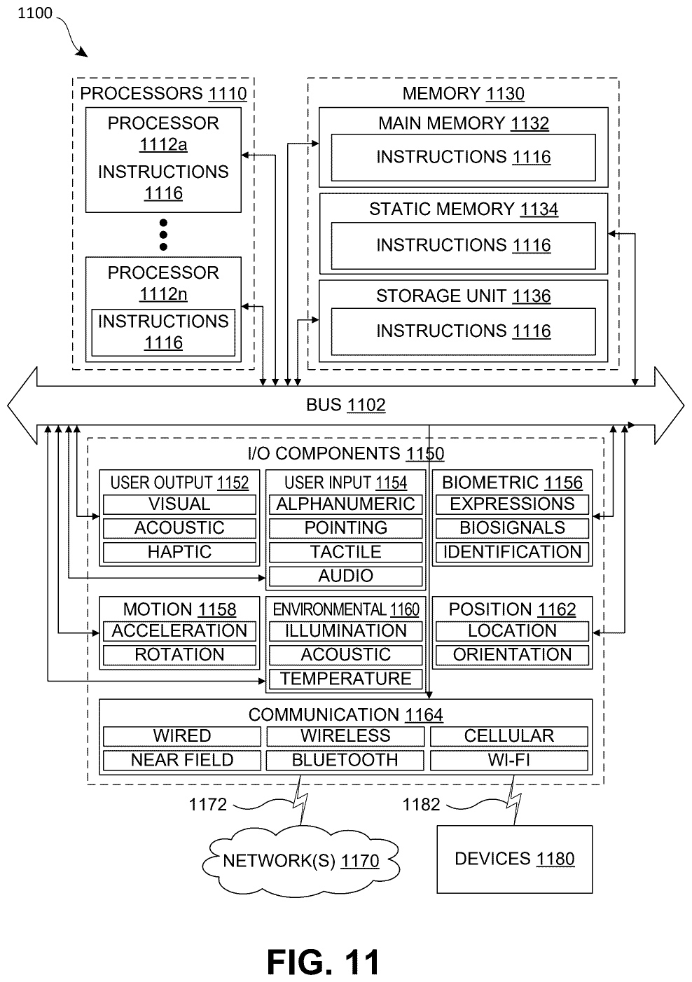

FIG. 10 is a block diagram 1000 illustrating an example software architecture 1002, various portions of which may be used in conjunction with various hardware architectures herein described, which may implement any of the above-described features. FIG. 10 is a non-limiting example of a software architecture, and it will be appreciated that many other architectures may be implemented to facilitate the functionality described herein. The software architecture 1002 may execute on hardware such as a machine 1100 of FIG. 11 that includes, among other things, processors 1110, memory 1130, and input/output (I/O) components 1150. A representative hardware layer 1004 is illustrated and can represent, for example, the machine 1100 of FIG. 11. The representative hardware layer 1004 includes a processing unit 1006 and associated executable instructions 1008. The executable instructions 1008 represent executable instructions of the software architecture 1002, including implementation of the methods, modules and so forth described herein. The hardware layer 1004 also includes a memory/storage 1010, which also includes the executable instructions 1008 and accompanying data. The hardware layer 1004 may also include other hardware modules 1012. Instructions 1008 held by processing unit 1006 may be portions of instructions 1008 held by the memory/storage 1010.

The example software architecture 1002 may be conceptualized as layers, each providing various functionality. For example, the software architecture 1002 may include layers and components such as an operating system (OS) 1014, libraries 1016, frameworks 1018, applications 1020, and a presentation layer 1044. Operationally, the applications 1020 and/or other components within the layers may invoke API calls 1024 to other layers and receive corresponding results 1026. The layers illustrated are representative in nature and other software architectures may include additional or different layers. For example, some mobile or special purpose operating systems may not provide the frameworks/middleware 1018.

The OS 1014 may manage hardware resources and provide common services. The OS 1014 may include, for example, a kernel 1028, services 1030, and drivers 1032. The kernel 1028 may act as an abstraction layer between the hardware layer 1004 and other software layers. For example, the kernel 1028 may be responsible for memory management, processor management (for example, scheduling), component management, networking, security settings, and so on. The services 1030 may provide other common services for the other software layers. The drivers 1032 may be responsible for controlling or interfacing with the underlying hardware layer 1004. For instance, the drivers 1032 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 1016 may provide a common infrastructure that may be used by the applications 1020 and/or other components and/or layers. The libraries 1016 typically provide functionality for use by other software modules to perform tasks, rather than rather than interacting directly with the OS 1014. The libraries 1016 may include system libraries 1034 (for example, C standard library) that may provide functions such as memory allocation, string manipulation, file operations. In addition, the libraries 1016 may include API libraries 1036 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 1016 may also include a wide variety of other libraries 1038 to provide many functions for applications 1020 and other software modules.

The frameworks 1018 (also sometimes referred to as middleware) provide a higher-level common infrastructure that may be used by the applications 1020 and/or other software modules. For example, the frameworks 1018 may provide various graphic user interface (GUI) functions, high-level resource management, or high-level location services. The frameworks 1018 may provide a broad spectrum of other APIs for applications 1020 and/or other software modules.

The applications 1020 include built-in applications 1040 and/or third-party applications 1042. Examples of built-in applications 1040 may include, but are not limited to, a contacts application, a browser application, a location application, a media application, a messaging application, and/or a game application. Third-party applications 1042 may include any applications developed by an entity other than the vendor of the particular platform. The applications 1020 may use functions available via OS 1014, libraries 1016, frameworks 1018, and presentation layer 1044 to create user interfaces to interact with users.

Some software architectures use virtual machines, as illustrated by a virtual machine 1048. The virtual machine 1048 provides an execution environment where applications/modules can execute as if they were executing on a hardware machine (such as the machine 1100 of FIG. 11, for example). The virtual machine 1048 may be hosted by a host OS (for example, OS 1014) or hypervisor, and may have a virtual machine monitor 1046 which manages operation of the virtual machine 1048 and interoperation with the host operating system. A software architecture, which may be different from software architecture 1002 outside of the virtual machine, executes within the virtual machine 1048 such as an OS 1050, libraries 1052, frameworks 1054, applications 1056, and/or a presentation layer 1058.

FIG. 11 is a block diagram illustrating components of an example machine 1100 configured to read instructions from a machine-readable medium (for example, a machine-readable storage medium) and perform any of the features described herein. The example machine 1100 is in a form of a computer system, within which instructions 1116 (for example, in the form of software components) for causing the machine 1100 to perform any of the features described herein may be executed. As such, the instructions 1116 may be used to implement modules or components described herein. The instructions 1116 cause unprogrammed and/or unconfigured machine 1100 to operate as a particular machine configured to carry out the described features. The machine 1100 may be configured to operate as a standalone device or may be coupled (for example, networked) to other machines. In a networked deployment, the machine 1100 may operate in the capacity of a server machine or a client machine in a server-client network environment, or as a node in a peer-to-peer or distributed network environment. Machine 1100 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1100 is illustrated, the term “machine” includes a collection of machines that individually or jointly execute the instructions 1116.

The machine 1100 may include processors 1110, memory 1130, and I/O components 1150, which may be communicatively coupled via, for example, a bus 1102. The bus 1102 may include multiple buses coupling various elements of machine 1100 via various bus technologies and protocols. In an example, the processors 1110 (including, for example, a central processing unit (CPU), a graphics processing unit (GPU), a digital signal processor (DSP), an ASIC, or a suitable combination thereof) may include one or more processors 1112a to 1112n that may execute the instructions 1116 and process data. In some examples, one or more processors 1110 may execute instructions provided or identified by one or more other processors 1110. The term “processor” includes a multi-core processor including cores that may execute instructions contemporaneously. Although FIG. 11 shows multiple processors, the machine 1100 may include a single processor with a single core, a single processor with multiple cores (for example, a multi-core processor), multiple processors each with a single core, multiple processors each with multiple cores, or any combination thereof. In some examples, the machine 1100 may include multiple processors distributed among multiple machines.

The memory/storage 1130 may include a main memory 1132, a static memory 1134, or other memory, and a storage unit 1136, both accessible to the processors 1110 such as via the bus 1102. The storage unit 1136 and memory 1132, 1134 store instructions 1116 embodying any one or more of the functions described herein. The memory/storage 1130 may also store temporary, intermediate, and/or long-term data for processors 1110. The instructions 1116 may also reside, completely or partially, within the memory 1132, 1134, within the storage unit 1136, within at least one of the processors 1110 (for example, within a command buffer or cache memory), within memory at least one of I/O components 1150, or any suitable combination thereof, during execution thereof. Accordingly, the memory 1132, 1134, the storage unit 1136, memory in processors 1110, and memory in I/O components 1150 are examples of machine-readable media.

As used herein, “machine-readable medium” refers to a device able to temporarily or permanently store instructions and data that cause machine 1100 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 1116) for execution by a machine 1100 such that the instructions, when executed by one or more processors 1110 of the machine 1100, cause the machine 1100 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 1150 may include a wide variety of hardware components adapted to receive input, provide output, produce output, transmit information, exchange information, capture measurements, and so on. The specific I/O components 1150 included in a particular machine will depend on the type and/or function of the machine. For example, mobile devices such as mobile phones may include a touch input device, whereas a headless server or IoT device may not include such a touch input device. The particular examples of I/O components illustrated in FIG. 11 are in no way limiting, and other types of components may be included in machine 1100. The grouping of I/O components 1150 are merely for simplifying this discussion, and the grouping is in no way limiting. In various examples, the I/O components 1150 may include user output components 1152 and user input components 1154. User output components 1152 may include, for example, display components for displaying information (for example, a liquid crystal display (LCD) or a projector), acoustic components (for example, speakers), haptic components (for example, a vibratory motor or force-feedback device), and/or other signal generators. User input components 1154 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1150 may include biometric components 1156, motion components 1158, environmental components 1160, and/or position components 1162, among a wide array of other physical sensor components. The biometric components 1156 may include, for example, components to detect body expressions (for example, facial expressions, vocal expressions, hand or body gestures, or eye tracking), measure biosignals (for example, heart rate or brain waves), and identify a person (for example, via voice-, retina-fingerprint-, and/or facial-based identification). The motion components 1158 may include, for example, acceleration sensors (for example, an accelerometer) and rotation sensors (for example, a gyroscope). The environmental components 1160 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 1162 may include, for example, location sensors (for example, a Global Position System (GPS) receiver), altitude sensors (for example, an air pressure sensor from which altitude may be derived), and/or orientation sensors (for example, magnetometers).

The I/O components 1150 may include communication components 1164, implementing a wide variety of technologies operable to couple the machine 1100 to network(s) 1170 and/or device(s) 1180 via respective communicative couplings 1172 and 1182. The communication components 1164 may include one or more network interface components or other suitable devices to interface with the network(s) 1170. The communication components 1164 may include, for example, components adapted to provide wired communication, wireless communication, cellular communication, Near Field Communication (NFC), Bluetooth communication, Wi-Fi, and/or communication via other modalities. The device(s) 1180 may include other machines or various peripheral devices (for example, coupled via USB).

In some examples, the communication components 1164 may detect identifiers or include components adapted to detect identifiers. For example, the communication components 1164 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1164, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system for an autonomous mobile robot, the data processing system comprising:
a processor; and
a memory in communication with the processor, the memory comprising executable instructions that, when executed by the processor, cause the data processing system to perform functions of:
generating a dynamic scene graph (DSG) of an environment in which the autonomous mobile robot is operating based on spatial configuration data of the environment, the DSG being generated offline;
generating a relational semantic network (RSN) and training the RSN to estimate probabilities of finding target objects in a plurality of different semantic room types using common-sense knowledge, the RSN being initialized and trained offline;
after the DSG and the RSN have been generated, receiving a user query at a control system of the autonomous mobile robot, the user query specifying a target object to search for in the environment;
generating a global search policy for the autonomous mobile robot which defines a plan for navigating through all rooms in the environment to find the target object using a global planner, the global search policy being generated based on relational semantic knowledge encoded in the RSN;
generating a robot control policy based on the global search policy using a local finite state controller, the robot control policy defining how the autonomous mobile robot searches each of the rooms in the environment; and
controlling the autonomous mobile robot according to the global search policy and the robot control policy.

2. The data processing system of claim 1, wherein the RSN comprises:
a pretrained text encoder that maps a class of the target object to a text embedding;
a multi-layer perceptron (MLP) that receives the text embedding and estimates probabilities of the target object being located in each of the semantic room types; and
a Bayesian network that estimates probabilities of the target object being located in each of the semantic room types based on the probabilities estimated by the MLP and based on historical data pertaining to searches for target objects.

3. The data processing system of claim 2, wherein the Bayesian network updates the probabilities of the target object being located in each of the semantic room types based on new environmental observations made by the autonomous mobile robot.

4. The data processing system of claim 1, wherein the global planner determines the global search policy by solving a Markov Decision Process (MDP).

5. The data processing system of claim 4, wherein:
the MDP is defined by a tuple that includes state space, action space, transition probabilities, and cost function,
the state space and the action space are extracted from room nodes in the DSG,
the transition probabilities correspond to probabilities of finding the target object in a next room searched according to the global search policy, and
the cost function is based on travel times between the rooms in the environment.

6. The data processing system of claim 1, wherein the local finite state controller comprises:
a global search controller which generates a navigation policy to visit a new room or search a current room based on global actions defined by the global search policy,
an active semantic search controller which plans a path that maximizes information gain of observing a potential target object, and
an object inspection controller which generates a plan to move the autonomous mobile robot to a detected target object and a robot pose when the autonomous mobile robot reaches the detected target object.

7. The data processing system of claim 6, wherein:
the path is selected to reduce the target object's pose and semantic detection uncertainty.

8. The data processing system of claim 6, wherein:
the active semantic search controller is triggered when the autonomous mobile robot detects a potential target object in a room using an object detector.

9. The data processing system of claim 7, wherein the MLP outputs (i) the probabilities of finding the target object in each of the semantic room types, and (ii) probabilities of finding the target object in each of the semantic room types without performing a careful search.

10. The data processing system of claim 1, wherein the functions further comprise:
updating the DSG based on changes to the environment and new environment information detected while the autonomous mobile robot is searching for the target object.

11. The data processing system of claim 1, wherein:
the DSG comprises a hierarchical representation of the environment that includes nodes corresponding to rooms, the nodes being partitioned into layers,
nodes connected by edges in the same level indicate spatial connectivity between the nodes, and
nodes on different levels connected by edges indicate that the nodes are spatially grouped together.

12. A method for performing object-goal navigation for an autonomous mobile robot, the method comprising:
generating a dynamic scene graph (DSG) of an environment in which the autonomous mobile robot is operating based on spatial configuration data of the environment, the DSG being generated offline;
training a relational semantic network (RSN) to estimate probabilities of finding target objects in a plurality of different semantic room types using common-sense knowledge, the RSN being initialized and trained offline;
after the DSG and the RSN have been generated, receiving a user query at a control system of the autonomous mobile robot, the user query specifying a target object to search for in the environment;
generating a global search policy for the autonomous mobile robot which defines a plan for navigating through all rooms in the environment to find the target object using a global planner, the global search policy being generated based on relational semantic knowledge encoded in the RSN;
generating a robot control policy based on the global search policy using a local finite state controller, the robot control policy defining how the autonomous mobile robot searches each of the rooms in the environment; and
controlling the autonomous mobile robot according to the global search policy and the robot control policy.

13. The method of claim 12, wherein the RSN comprises:
a pretrained text encoder that maps a class of the target object to a text embedding;
a multi-layer perceptron (MLP) that receives the text embedding and estimates probabilities of the target object being located in each of the semantic room types; and
a Bayesian network that estimates probabilities of the target object being located in each of the semantic room types based on the probabilities estimated by the MLP and based on historical data pertaining to searches for target objects.

14. The method of claim 13, wherein the Bayesian network updates the probabilities of the target object being located in each of the semantic room types based on new environmental observations made by the autonomous mobile robot.

15. The method of claim 12, wherein:
the global planner determines the global search policy by solving a Markov Decision Process (MDP),
the MDP is defined by a tuple that includes state space, action space, transition probabilities, and cost function,
the state space and the action space are extracted from room nodes in the DSG,
the transition probabilities correspond to probabilities of finding the target object in a next room searched according to the global search policy, and
the cost function is based on travel times between the rooms in the environment.

16. The method of claim 12, wherein the local finite state controller comprises:
a global search controller which generates a navigation policy to visit a new room or search a current room based on global actions defined by the global search policy,
an active semantic search controller which plans a path that maximizes information gain of observing a potential target object, and
an object inspection controller which generates a plan to move the autonomous mobile robot to a detected target object and a robot pose when the autonomous mobile robot reaches the detected target object.

17. The method of claim 16, wherein:
the active semantic search controller is triggered when the autonomous mobile robot detects a potential target object in a room using an object detector.

18. The method of claim 12, wherein the functions further comprise:
updating the DSG based on changes to the environment and new environment information detected while the autonomous mobile robot is searching for the target object.

19. A non-transitory computer readable medium on which are stored instructions that, when executed, cause a programmable device to perform functions of:
generating a dynamic scene graph (DSG) of an environment in which a autonomous mobile robot is operating based on spatial configuration data of the environment, the DSG being generated offline;
training a relational semantic network (RSN) to estimate probabilities of finding target objects in a plurality of different semantic room types using common-sense knowledge, the RSN being initialized and trained offline;
after the DSG and the RSN have been generated, receiving a user query at a control system of the autonomous mobile robot, the user query specifying a target object to search for in the environment;
generating a global search policy for the autonomous mobile robot which defines a plan for navigating through all rooms in the environment to find the target object using a global planner, the global search policy being generated based on relational semantic knowledge encoded in the RSN;
generating a robot control policy based on the global search policy using a local finite state controller, the robot control policy defining how the autonomous mobile robot searches each of the rooms in the environment; and
controlling the autonomous mobile robot according to the global search policy and the robot control policy.

20. The non-transitory computer readable medium of claim 19, wherein the RSN comprises:
a pretrained text encoder that maps a class of the target object to a text embedding;
a multi-layer perceptron (MLP) that receives the text embedding and estimates probabilities of the target object being located in each of the semantic room types; and
a Bayesian network that estimates probabilities of the target object being located in each of the semantic room types based on the probabilities estimated by the MLP and based on historical data pertaining to searches for target objects.
